(19) United States
(12) Patent Application Publication
(10) Pub. No.: US 2024/0195667 A1
(43) Pub. Date: Jun. 13, 2024

(54) METHODS, ARCHITECTURES, APPARATUSES AND SYSTEMS DIRECTED TO INITIAL ACCESS IN HIGHER FREQUENCIES

(71) Applicant: InterDigital Patent Holdings, Inc., Wilmington, DE (US)

(72) Inventors: Nazli KHAN BEIGI, Longueuil (CA); Young Woo KWAK, Woodbury, NY (US); Moon Il LEE, Melville, NY (US); Paul MARINIER, Brossard (CA)

(21) Appl. No.: 18/285,708

(22) PCT Filed: Mar. 31, 2022
(86) PCT No.: PCT/US2022/022824

§ 371 Date: Oct. 5, 2023

Related U.S. Application Data
(60) Provisional application No. 63/309,490, filed on Feb. 11, 2022.
(60) Provisional application No. 63/185,656, filed on May 7, 2021.
(60) Provisional application No. 63/170,806, filed on Apr. 5, 2021.

(51) Int. Cl. H04L 27/26; H04J 3/06; H04L 5/00

(52) U.S. Cl. CPC H04L 27/2613; H04J 3/0685; H04L 5/0053

(57) ABSTRACT

Procedures, methods, architectures, apparatuses, systems, devices, and computer program products directed to initial access in higher frequencies are provided. Among the methods is a method that may be implemented in a wireless transmit/receive unit and that may include any of receiving a first transmission having a frequency component that carries synchronization signal information and that corresponds to one sync-raster value of a plurality of values of a sync raster; determining one or more parameters based on (i) the one sync-raster value being a member of a partition of a plurality of partitions of the sync raster; and (ii) the partition being indicative of a mode of operation; and receiving a second transmission using the one or more parameters, wherein the second transmission comprises control channel information.

### CROSS-REFERENCE TO RELATED APPLICATIONS

This application claims the benefit of U.S. Provisional Patent Application Nos. (i) 63/170,806 filed 5 Apr. 2021, (ii) 63/185,656 filed 7 May 2021, and (iii) 63/309,490 filed 11 Feb. 2022; each of which is incorporated herein by reference.

### BACKGROUND

### Field

This disclosure pertains to methods and apparatus for wireless communication and particularly relates to initial access in higher frequencies.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating sync raster set association with a mode of operation in accordance with an embodiment;

FIG. 3 is a block diagram illustrating Cell PCID range association with a mode of operation in accordance with an embodiment;

FIG. 4, including FIGS. 4(a)-4(e), is a block diagram illustrating examples of preconfigured CORESET #0 associated with SSBs for Case D, SCS 120 kHz, 16 beams in accordance with one or more embodiments;

FIG. 5 is a flow diagram illustrating a method of initial access in higher frequencies in a wireless communication system in accordance with an embodiment;

FIG. 6 is a flow diagram illustrating a method of initial access in higher frequencies in a wireless communication system in accordance with an embodiment; and

FIG. 7 is a flow chart illustrating an example flow.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communications Systems

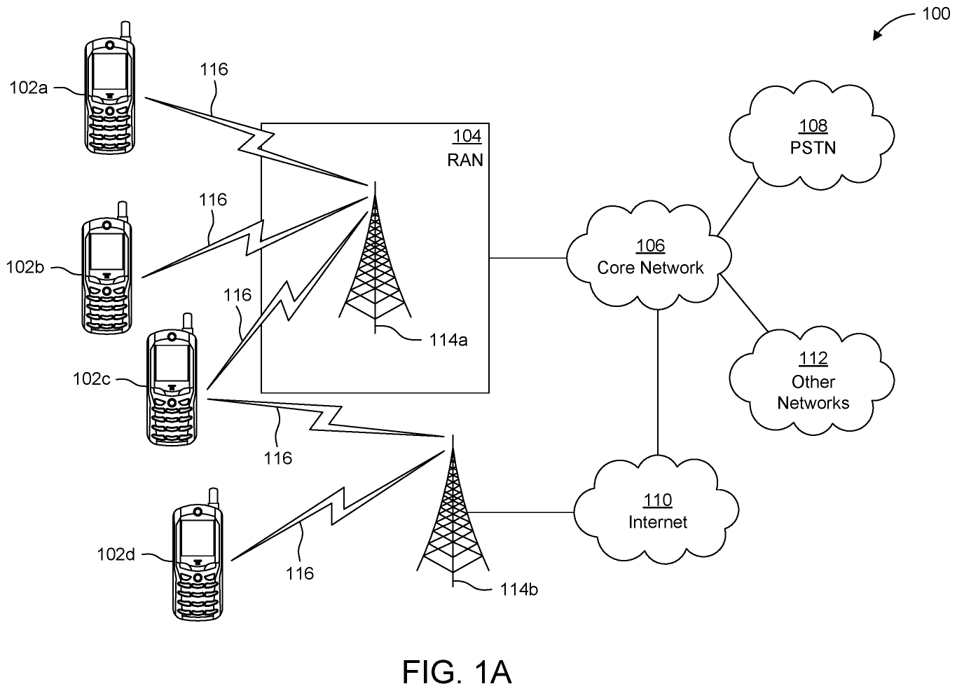

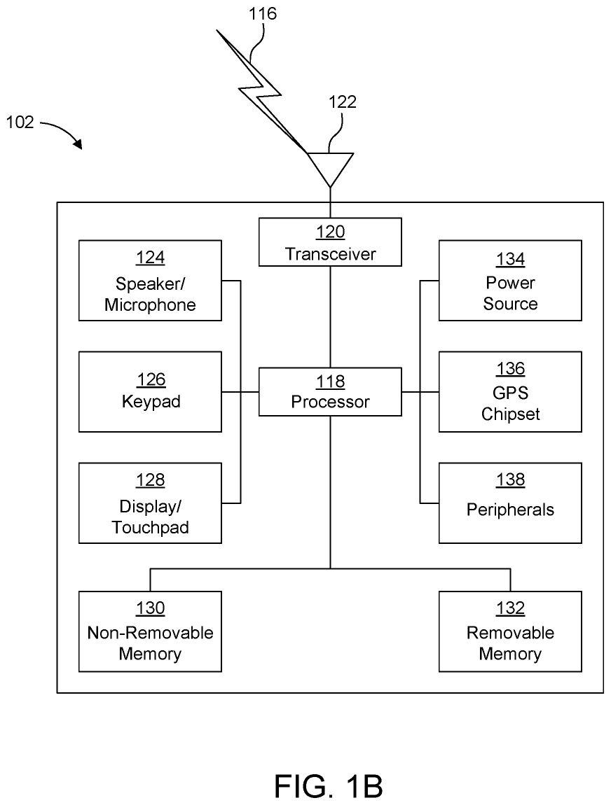

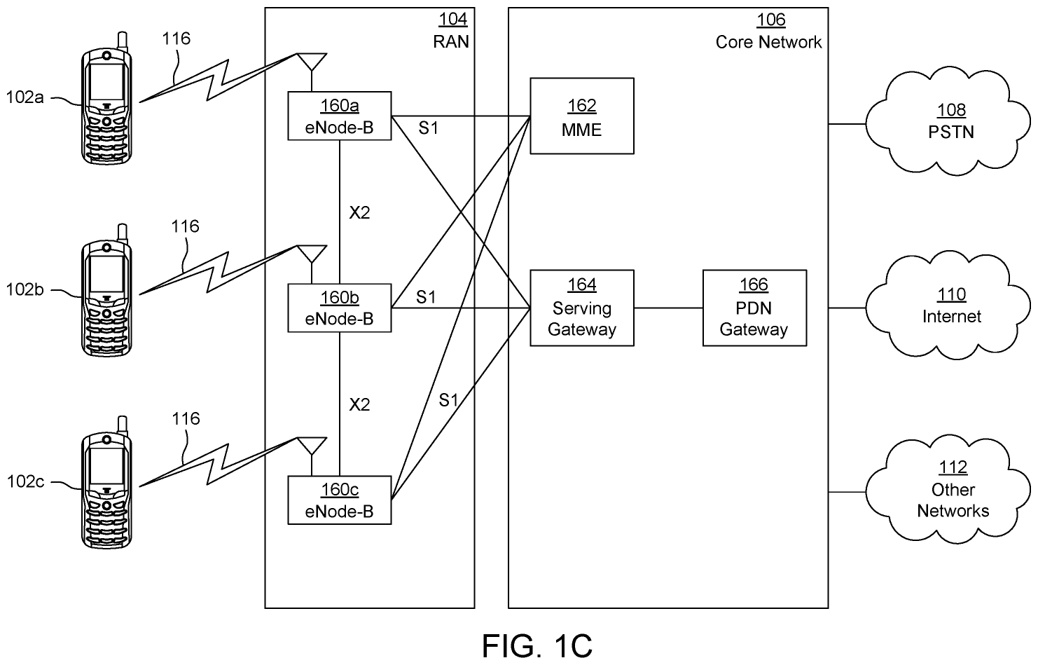

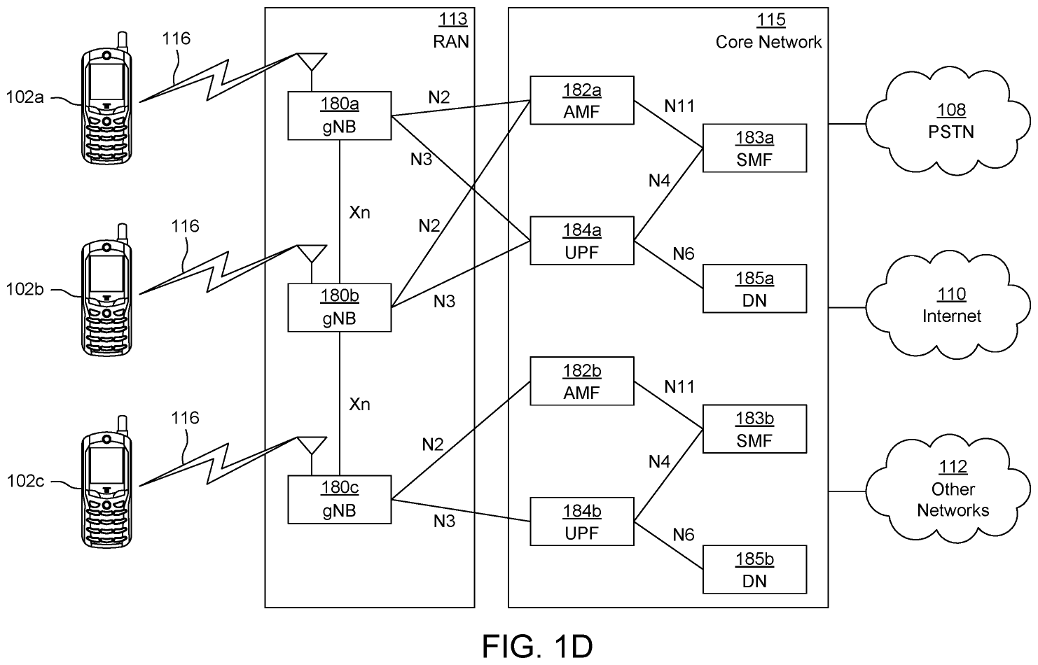

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11(i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n_{Q}, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n_{Q}, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different physical data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Initial Access in Higher Frequencies

In RAN #80, a new RAN study item on New Radio (NR) beyond 52.6 GHz has been agreed upon. This technology could be the foundation for the future high data rate frameworks. The realization of beyond 52.6 GHz systems is subject to resolving the key challenges raised due to the special channel and radiation characteristics. Moreover, in RAN #90, an updated work item description (WID) was agreed upon to extend the NR operation considering both licensed and unlicensed operation. In the WID, the number of synchronization signal/physical broadcast channel (SS/PBCH) block (also referred to as synchronization signal block (SSB)) beams was extended to 64 beams for both licensed and unlicensed spectrum. The 120 kHz subcarrier spacing (SCS) was agreed upon to be supported for SSB as well as for initial access related signals/channels in an initial bandwidth part (BWP). Also, additional SCS (240 kHz, 480 kHz, and 960 kHz) for SSB and additional SCS (480 kHz, 960 kHz) for initial access related signals and/or channels in an initial BWP are under study. Herein, the terms “SS/PBCH block”, “synchronization signal block”, “SSB”, “SS block” and “synchronization block” may be used interchangeably and still consistent with this invention.

To accommodate the agreements in the WID regarding the NR unlicensed bands, initial access procedures need enhancements in the corresponding shared spectrum beyond (greater than and/or equal to) 52.6 GHz. In shared spectrum, carrying out listen before talk (LBT) procedures is mandatory in many regions. As such, clear channel assessment (CCA) is performed before every single transmission using energy sensing. In NR unlicensed (NR-U), discovery burst transmission windows (DBTWs) have been used to prevent frequent CCA and/or LBT procedures. However, the DBTW has a limit on the gap between the transmissions that should not be larger than 16 us.

Moreover, in NR beyond 52.6 GHz bands, the licensed and unlicensed bands may overlap in some regions. For instance, various bands above 52.6 GHz are used with different license regimes throughout European countries. This may cause ambiguity at a WTRU during initial access, particularly on how to interpret different parameters within the SSBs.

The impressive features in NR beyond 52.6 GHz along with the existing challenges to include the shared spectrum have motivated the concepts of this disclosure. The methodology for indication of license regime in overlapping bands has been proposed. Also, proposals for occupying the channel in shared spectrum are provided to avoid the gaps.

The present disclosure presents several issues that arise in NR and offers to address those issues. For example, in NR beyond 52.6 GHz bands, a WTRU should identify the license regime in a corresponding band. Additionally, in a LBT operation in NR-U at beyond 52.6 GHz bands, SSB patterns should be enhanced to ensure transmission gaps lower than 16 us. Also, in NR beyond 52.6 GHz bands, new parameters should be added, or existing parameters should be repurposed to support 64 SSB beams in NR-U as well as the support for different numerologies in initial access.

The present disclosure addresses these and other issues. For instance, the present disclosure presents embodiments that provide enhancements on the SS/PBCH blocks in initial access. The present disclosure also presents embodiments that entail implicit and explicit identification of the license regime before and/or during initial access. As for channel occupancy in NR-U with LBT operation, the present disclosure presents embodiments with preconfigured locations for a control resource set (CORESET) #0, followed by possible changes and enhancements on the parameters in a master information block (MIB).

Among the procedures, methods, architectures, apparatuses, systems, devices, and computer program products is a method that may include any of: receiving a first transmission having a frequency component that may carry synchronization signal information and that may correspond (e.g., align) to one sync-raster value of a plurality of values of a sync raster; determining one or more parameters based on (i) the one sync-raster value being a member of a partition of a plurality of partitions of the sync raster, and (ii) the partition being indicative of a mode of operation; and receiving a second transmission using the one or more parameters, wherein the second transmission may include control channel information.

In various embodiments, the control channel information may be and/or include physical downlink control channel information. In various embodiments, the frequency component is any of a subcarrier and a subchannel.

In various embodiments, the method may include transmitting an uplink transmission without performing a listen-before-talk operation based on the mode of operation being a first mode of operation. In various embodiments, the method may include any of: performing a listen-before-talk operation based on the mode of operation being a second mode of operation; and transmitting an uplink transmission following an outcome of the listen-before-talk operation indicating a channel is available.

In various embodiments, the method may include, based on the mode of operation being a second mode of operation, any of performing a listen-before-talk operation based on the mode of operation being a second mode of operation; and transmitting an uplink transmission following an outcome of the listen-before-talk operation indicating a channel is available.

In various embodiments, the method may include partitioning the sync raster into the plurality of partitions. In various embodiments, the plurality of partitions may be indicative of a respective plurality of modes of operation. In various embodiments, the partition may be any one of the plurality of partitions. In various embodiments, the partition may be based on a function applied to the plurality of sync-raster values. In various embodiments, each of the plurality of partitions may be based on a corresponding (e.g., respective) function applied to the plurality of sync-raster values. In various embodiments, the partition may be based on an initial sync-raster value and a step function applied to the plurality of sync-raster values. In various embodiments, each of the plurality of partitions may be based on an initial sync-raster value and a step function applied to the plurality of sync-raster values.

In various embodiments, the first mode of operation may be, may include and/or may correspond or to licensed band operation. In various embodiments, the second mode of operation may be, may include and/or may correspond to unlicensed band operation.

In various embodiments, the parameters may be, include and/or correspond to any of one or more (e.g., consecutive) resource blocks, a number of (e.g., consecutive) resource blocks, one or more (e.g., consecutive) symbols, a number of (e.g., consecutive) symbols, a frequency offset, and a multiplexing pattern for/associated with a second transmission (e.g., associated with CORESET and/or a search space). In various embodiments, determining one or more parameters may include any of determining the mode of operation based on (i) the one sync-raster value being a member of the partition of the plurality of partitions of the sync raster; and (ii) the partition being indicative of the mode of operation; and determining the one or more parameters based on the determined mode of operation.

In various embodiments, the method may include transmitting information indicating one or more of the one or more parameters. In various embodiments, the information indicating one or more of the parameters may be, include and/or be indicated in a report.

Among the procedures, methods, architectures, apparatuses, systems, devices, and computer program products is an apparatus configured to perform at least the foregoing method. In various embodiments, the apparatus may be, may include and/or may be configured with circuitry, including a transmitter, a receiver, a processor and memory.

In various embodiments of any of the method and the apparatus, the apparatus may be a transmit/receive unit and/or may be, may include and/or may be configured as any one of a user equipment, a station, a base station, and an access point.

Some implementations advantageously employ initial access enhancement based on sync raster offsets. For example, a WTRU may monitor for one or more synchronization signals (primary synchronization signal (PSS), secondary synchronization signal (SSS), and/or SSB) on one or more synchronization raster frequencies in a frequency band where each of the one or more synchronization raster frequencies corresponds to a base frequency plus an integer multiple of a raster frequency plus a raster offset. The WTRU may receive the synchronization signals on a frequency of the one or more frequencies that corresponds to a raster offset with a first value or a second value. When the raster offset is a first value, the WTRU may determine a first mode of operation (e.g., unlicensed or shared spectrum operation). When the raster offset is a second value, the WTRU may determine a second mode of operation (e.g., licensed or not shared spectrum operation). The WTRU may determine parameters of a CORESET or a search space for receiving a physical downlink control channel (PDCCH) transmission based on the determined mode of operation. Alternatively, and/or additionally, the WTRU may determine parameters of a CORESET or an SS for receiving a PDCCH transmission based on the raster offset value. The WTRU may receive the PDCCH transmission in the CORESET or search space based on the determined parameters.

Some implementations advantageously employ initial access enhancement based on physical cell identities (IDs). A WTRU may monitor for one or more synchronization signals (PSS, SSS, and/or SSB) where each of the one or more synchronization signals are associated with or generated with a physical cell ID. The WTRU may receive the synchronization signals and determine a physical cell ID based on the synchronization signals. The WTRU may determine a mode of operation based on the physical cell ID. The mode of operation may, for example, be unlicensed (or shared spectrum) operation or licensed (or non-shared spectrum) operation. For example, when the physical cell ID is a first value, within a first range or lower than (or equal to) a first value, the WTRU may determine a first mode of operation (e.g., unlicensed or shared spectrum operation) and/or when the physical cell ID is a second value, within a second range or higher than (or equal to) a second value, the WTRU may determine a second mode of operation (e.g., licensed or non-shared spectrum operation). The WTRU may determine parameters of a CORESET or a search space for receiving a PDCCH transmission based on the determined mode of operation. Alternatively, and/or additionally, the WTRU may determine parameters of a CORESET or a search space for receiving a PDCCH transmission based on the physical cell ID. The WTRU may receive the PDCCH transmission in the CORESET or the search space based on the determined parameters.

Some implementations advantageously employ new contents of one or more MIBs. The WTRU may receive one or more PBCH transmissions associated with the received synchronization signals, and the WTRU may receive and/or decode one or more of the MIBs received from the PBCH transmissions. The WTRU may determine contents of the MIBs that are associated with a first mode of operation based on, responsive to and/or on condition that the first mode of operation being/is determined by the WTRU. Alternatively, and/or additionally, the WTRU may determine contents of the MIBs that are associated with the first mode of operation based on, responsive to and/or on condition that a raster offset being/is a first value (e.g., a first raster offset value). Alternatively, and/or additionally, the WTRU may determine contents of the MIBs that are associated with the first mode of operation based on, responsive to and/or on condition that a value of a physical cell ID (PCID) being/is a first value (e.g., a first PCID value). Alternatively, and/or additionally, the WTRU may determine contents of the MIBs that are associated with the first mode of operation based on, responsive to and/or on condition that a value of a PCID being/is in a first range of values (e.g., a first range of PCID values). The WTRU may determine a frequency offset, a number of resource blocks (RBs), a number of symbols, and multiplexing patterns of a CORESET #0 based on the contents of the MIBs (e.g., information element (IE) controlResourceSetZero and IE searchSpaceZero) and/or settings (e.g., defined or (pre)configured settings).

Alternatively, the WTRU may determine contents of the MIBs that are associated with a second mode of operation based on, responsive to and/or on condition the second mode of operation being/is determined by the WTRU. Alternatively, and/or additionally, the WTRU may determine contents of the MIBs that are associated with the second mode of operation based on, responsive to and/or on condition that the value of the raster offset being/is a second value (e.g., a second raster offset value). Alternatively, and/or additionally, the WTRU may determine contents of the MIBs that are associated with the second mode of operation based on, responsive to and/or on condition that the value of the PCID being/is a second value (e.g., a second PCID value). Alternatively, and/or or additionally, the WTRU may determine contents of the MIBs that are associated with the second mode of operation based on, responsive to and/or on condition that the value of the PCID being/is in a second range of values (e.g., in a second range of PCID values). The WTRU may determine a frequency offset, a number of RBs, a number of symbols, and multiplexing patterns of a CORESET #0 based on the contents of the MIBs (e.g., IE controlResourceSetZero and IE searchSpaceZero) in the decoded MIBs and/or settings (e.g., defined or (pre)configured settings).

In various embodiments, one or more modes of operation and/or one or more parameters (including, e.g., Q parameters) may be indicated and/or determined based on a demodulation reference signal (DMRS) detected in, determined from and/or decoded from a PBCH transmission. By way of example, a WTRU may implement a method that may include any of: receiving one or more transmissions including a PSS and an SSS; detecting, determining and/or decoding a DMRS in (and/or associated with) a PBCH based on the PSS and the SSS; determining a plurality of parameters associated with the DMRS; and determining at least one mode of operation based on the plurality of parameters.

In various embodiments, determining the at least one mode of operation may include determining the at least one mode of operation based on an association between the at least one mode of operation and the plurality of parameters. In various embodiments, the method may include performing and/or operating in accordance with at least one or the at least one mode of operation. In various embodiments, performing and/or operating in accordance with at least one or the at least one mode of operation may include performing and/or operating in accordance with at least one of the at least one mode of operation based on an association between at least one of the at least one mode of operation and the plurality of parameters.

In various embodiments, the plurality of parameters associated with the DMRS may be a first plurality of parameters, and/or detecting, determining and/or decoding a DMRS may include any of: determining first and second parameters from the PSS and the SSS; determining candidate values for a second plurality of parameters for each of one or more candidate parameter sets; determining a candidate step size and a candidate offset of each (any) of one or more indexes in one or more parameter sets based on the determined candidate values of the second plurality of parameters; determining one or more candidate index values for each of the one or more candidate parameter sets based on the corresponding candidate step size and the corresponding candidate offset; determining one or more initialization values based on the one or more candidate index values; determining a candidate DMRS sequence associated with each initialization value of the one or more initialization values for each candidate parameter set; and determining one or more parameter sets of the candidate parameter sets by detecting, determining and/or decoding one or more DMRS sequences of the determined candidate DMRS sequences that are associated with the one or more parameter sets.

In various embodiments, the first and second parameters may be a cell identifier and at least a portion of a candidate synchronization signal block index. In various embodiments, the second plurality of parameters may be a weighting factor n_{Q}, a factor r and at least a portion of a candidate synchronization signal block index. In various embodiments, the candidate offset may be a starting offset.

In various embodiments, determining the first plurality of parameters may include determining the first plurality of parameters from a third plurality of parameters associated with the determined one or more parameter sets. In various embodiments, the method may include determining three least significant bits of a synchronization signal block index based on at least one of the plurality of parameters.

In various embodiments, one or more transmissions including an SSB maybe received. One or more parameters from the SSB, e.g., one or more parts and/or components of the SSB, such as a PSS and/or an SSS, may be determined, obtained, extracted, etc. The parameters may include, e.g., a cell ID (N_{ID}^{cell}) and i_{SSB}.

Possible candidate values for the weighting factor n_{Q}, the factor r and i_{SSB} for each of one or more candidate PBCH DMRS sets may be determined.

A candidate step size and a candidate offset (e.g., starting offset) of each (any) of the one or more indexes in the PBCH DMRS sets may be determined, e.g., based on the candidate values of i_{SSB}, the candidate values of the factor r, and the candidate values of the weighting factor n_{Q}.

One or more candidate index values, e.g., ι̅_{SSB}, for each candidate PBCH DMRS set may be determined. For example, the candidate indexes may be calculated, e.g., ι̅_{SSB}, using equation 2 infra and the candidate step sizes and candidate offsets.

One or more initialization values, e.g., cᵢₙᵢₜ, may be determined. A candidate DMRS sequence associated with each initialization value of the initialization values for each candidate PBCH DMRS set may be determined.

One or more PBCH DMRS sets of the candidate PBCH DMRS sets may be determined. The PBCH DMRS sets of the candidate PBCH DMRS sets may be determined by detecting and/or determining one or more DMRS sequences, of the determined candidate DMRS sequences, associated with the one or more PBCH DMRS sets.

Parameters associated with the determined one or more PBCH DMRS sets may be determined. For example, the DMRS index, i.e., ι̅_{SSB}, in the respective PBCH may be determined and/or the corresponding values of the factor r and the weighting factor n_{Q} may be determined.

One or more modes of operation based on the determined parameters may be determined and/or performed. For example, a mode of operation may be determined and/or that mode of operation may be performed and/or operation in accordance with that mode may be performed based on an association between the mode of operation the determined parameters. Three LSB bits of the candidate SSB index may be determined, e.g., based on an equation, such as i_{SSB}=(ι̅_{SSB} mod r), where the factor r is one of the determined parameters.

The remaining bits of the candidate SSB index may be obtained and/or determined. One or more operations may be performed based on the candidate SSB index, including reporting the candidate SSB index to the network (e.g., base station), making and/or configuring for various measurements, determining PRACH resources, etc.

In various embodiments, a WTRU may determine one or more bits (e.g., additional bits) for Q indication based on a PBCH DMRS sequence. The WTRU may detect a cell ID (N_{ID}^{cell}). The WTRU may determine one or more candidate values for factor r. For example, the WTRU may determine the candidate r values based on one or more of a frequency range, a license regime, a maximum number of SSBs, and so forth.

The WTRU may determine one or more candidate values for ι̅_{SSB} (“candidate ι̅_{SSB} values”). For example, the WTRU may determine the candidate ι̅_{SSB} values based on the determined candidate r values, one or more candidate values of the weighting factor n_{Q}, and one or more values of the 3 LSB of candidate SSB indexes i_{SSB}, and an equation, such as, ι̅_{SSB}=i_{SSB}+rn_{Q}.

The WTRU may determine one or more initialization values (e.g., one or more candidate values for cᵢₙᵢₜ) for each of the determined candidate ι̅_{SSB} values. For example, the WTRU may determine each of the one or more candidate values for cᵢₙᵢₜ value based on an equation, such as cᵢₙᵢₜ=2¹¹(ι̅_{SSB}+1)(└N_{ID}^{cell}/4┘+1)+2⁶(ι̅_{SSB}+1)+(N_{ID}^{cell} mod 4).

The WTRU may detect a corresponding PBCH DMRS associated with the detected SSB. For example, the WTRU may detect a corresponding PBCH DMRS associated with the detected SSB based on one of the calculated/determined candidate cᵢₙᵢₜ values. The WTRU may determine an ι̅_{SSB} value associated with the cᵢₙᵢₜ value of the detected PBCH DMRS.

The WTRU may decode the PBCH DMRS. The WTRU may determine a value of the Q parameter based on the PBCH DMRS index. For example, the WTRU may determine the value of the Q parameter to be a first value based on, responsive to and/or on condition that the PBCH DMRS index corresponds to a first (e.g., parameter) set. The WTRU may determine the value of the Q parameter to be a second value (different than the first value) based on, responsive to and/or on condition that the PBCH DMRS index corresponds to a second set.

In various embodiments, when ι̅_{SSB}=i_{SSB}, the WTRU may determine a band to be licensed and n_{Q}=0. Otherwise, the WTRU may determine the band to be unlicensed and n_{Q}=1. In various embodiments, the WTRU may determine the value of the factor r based on, responsive to and/or on a condition of determining that n_{Q}=1.

The WTRU may determine three LSB bits of the candidate SSB index. For example, the WTRU may determine the three LSB bits of the candidate SSB index based on an equation, such as i_{SSB}=(ι̅_{SSB} mod r), where the factor r is one of the determined parameters.

The WTRU may obtain and/or determine the remaining bits of the candidate SSB index. The WTRU may perform one or more operations based on the candidate SSB index, including reporting the candidate SSB index to the network (e.g., base station), making and/or configuring for various measurements, determining PRACH resources, etc.

### Definition of Beam

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (such as channel state information reference signal (CSI-RS)) or a SS block. The WTRU transmission may be referred to as “target”, and the received reference signal or SS block may be referred to as “reference” or “source”. In such a case, the WTRU may be said to transmit the target physical channel or signal according to a spatial relation with a reference to such a reference signal or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC, or signaled by one or more MAC control elements (MAC CEs) or downlink control information (DCI). For example, a WTRU may implicitly transmit physical uplink shared channel (PUSCH) and DMRS of PUSCH according to the same spatial domain filter as a sounding reference signal (SRS) indicated by an SRS resource indicator (SRI) indicated in DCI or configured by RRC. In another example, a spatial relation may be configured by RRC for an SRI or signaled by MAC CE for a physical uplink control channel (PUCCH). Such a spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or physical downlink shared channel (PDSCH) and its respective DMRS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DMRS by an index to a set of TCI states configured by RRC and/or signaled by MAC CE. Such an indication may also be referred to as a “beam indication”.

### Indication of License Regime in Overlapping Bands

Hereafter, operation with or without shared spectrum channel access can be interchangeably used with unlicensed or licensed bands, respectively. Hereafter, the term unlicensed spectrum may be used to refer to license exempt spectrum and lightly licensed spectrum.

Hereafter, the terms CORESET #0, Type0-PDCCH, and/or system information block 1 (SIB1) may be used interchangeably but still consistent with the present disclosure.

Hereafter, the term indication/identification of license regime may be interchangeably used with the terms indication/identification of support of discovery burst or indication and/or identification of support of DBTW.

### Implicit Identification of License Regime

### Mode of Operation Indication Based on Sync Raster Set

A channel raster may define a subset of RF reference frequencies that can be used to identify an RF channel position in an uplink and/or a downlink for a physical carrier.

A synchronization raster may indicate the frequency positions of a synchronization block (e.g., SS/PBCH block) that can be used by a WTRU for system acquisition when explicit signaling indicating the frequency positions of the synchronization block is not present (provided, used, etc.). Hereafter, a frequency raster may be referred to as a channel raster and/or a synchronization raster (sync raster). Also, operating frequency band, physical carrier, physical carrier band, and system band may be interchangeably used.

Two types of frequency rasters (e.g., a channel raster and a sync raster) may be used to reduce initial cell search complexity, especially for a large frequency band, such as occurs in NR. For example, a center frequency of a physical carrier may be located at one of the channel raster reference frequencies and an associated sync raster may be located at one of the sync raster frequencies. The set of sync raster frequencies may be a subset of the channel raster reference frequencies. A WTRU may search only a subset of a channel raster reference frequencies, which may reduce blind detection complexity at the WTRU receiver. Hereafter, raster, raster frequency, raster RF reference frequency, and raster reference frequency may be used interchangeably.

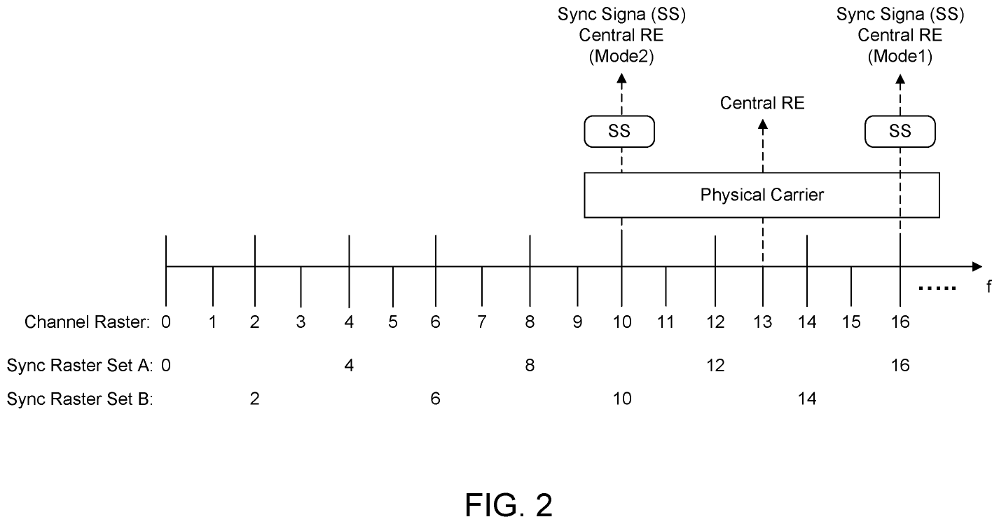

Referring to FIG. 2, one or more sync raster sets may be used, defined, configured, or determined, and each of the sync raster sets may be a subset of a channel raster. In an example, two sync raster sets may be used, defined, or configured with a channel raster. A sync raster set may be mutually exclusive to another sync raster set. For example, a sync raster set for mode 1 (i.e., licensed communication mode) may be constrained to lie within a predefined range and a sync raster set for mode 2 (i.e., unlicensed communication mode) may be constrained to lie outside the predefined range. If a WTRU observes that a sync raster set falls within the predefined range, then the WTRU may know to use mode 1 for wireless communications. Conversely, if a WTRU observes that a sync raster set falls outside the predefined range, then a WTRU may know to use mode 2 for wireless communications.

In some implementations, a sync raster step size may be an integer multiple of the channel raster step size. For example, if channel raster step size is Δ_{c}, a sync raster step size may be Δₛ=N×Δ_{c} where N may be a positive integer number. The sync raster step size here may be two adjacent RF reference frequencies.

Alternatively, or additionally, a sync raster set may be determined based on sync raster step size (e.g., N) and starting offset. For example, a first sync raster set may include a channel raster with a first sync raster step size (e.g., N₁) and a first start channel raster index (e.g., 0). A second sync raster set may include a channel raster with a second raster step size and a second start channel raster index (e.g., 2). The first sync raster step size and the second sync raster step size may be the same.

Alternatively, or additionally, a first set of RF reference frequencies may be used for a first sync raster set and a second set of RF reference frequencies may be used for a second sync raster set. The first RF reference frequencies may be mutually exclusive to the second RF reference frequencies.

Alternatively, or additionally, the number of sync raster sets used for an operating band may be determined based on frequency band, duplex mode (e.g., time division duplex (TDD) or frequency division duplex (FDD)), and/or geographical location (e.g., country, zone, zone identity).

Hereafter, sync raster set may be used interchangeably with sync raster monitoring set, sync raster type, sync raster mode, sync raster frequencies, and sync raster RF references.

In some implementations, one or more sync raster sets may be used and each sync raster set may be associated with a mode of operation. For example, if a WTRU detects a synchronization signal (SS) in a first sync raster set, the WTRU may perform a first mode of operation associated with the first sync raster set; if the WTRU detects a synchronization signal in a second sync raster set, the WTRU may perform a second mode of operation associated with the second sync raster set, and so forth. Various modes of operation are contemplated.

One mode of operation corresponds to SSS reception. For example, when a WTRU detects a PSS in a first sync raster set, the WTRU may detect or receive an associated SSS in a first mode of operation. When the WTRU detects a PSS in a second sync raster set, the WTRU may detect or receive an associated SSS in a second mode of operation. A set of sequences for the SSSs may be different based on the mode of operation. A time location of the SSSs may be different based on the mode of operation.

Another mode of operation corresponds to PBCH reception. For example, when a WTRU detects or receives an SS in a first sync raster set, the WTRU may receive an associated PBCH in a first mode of operation. When the WTRU detects or receives an SS in a second sync raster set, the WTRU may receive an associated PBCH in a second mode of operation. One or more bit fields of the PBCHs (e.g., MIBs) may be interpreted differently based on the mode of operation. For example, a bit field in a PBCH may be used for a first indication (e.g., a Type-0 PDCCH search space configuration) in a first mode of operation and the bit field may be used for a second indication (e.g., unlicensed band operation related information) in a second mode of operation. A DMRS sequence of a PBCH may be determined based on the mode of operation, and a DMRS location within a PBCH may be determined based on the mode of operation. Time and/or frequency locations of a PBCH may be determined based on the mode of operation

Another mode of operation corresponds to SSB configuration. For example, time and/or frequency locations of an SSB and/or a maximum number of SSBs may be different based on the mode of operation. A WTRU may perform SSB detection procedures based on the determined mode of operation (e.g., which may be determined based on a sync raster set).

Another mode of operation corresponds to Type-0 PDCCH search space monitoring. For example, a WTRU may receive a Type-0 PDCCH search space configuration from the associated PBCH when/if the WTRU receives or detects an SSB in a first sync raster set. Full or partial configuration information for Type-0 PDCCH search space may be predefined or pre-configured when/if the WTRU receives or detects SSB in a second sync raster set.

Another mode of operation corresponds to sensing before transmission. Whether a WTRU performs sensing (e.g., listen before talk) before transmission may be determined based on the mode of operation. For example, a WTRU may perform sensing before an uplink transmission (e.g., a PUSCH transmission, a PUCCH transmission, a physical random access channel (PRACH) transmission, an SRS transmission) based on, responsive to and/or on condition that the WTRU receives and/or detects an SSB in a first sync raster set. A WTRU may not perform sensing before performing an uplink transmission based on, responsive to and/or on condition that the received SSB is in a second sync raster set.

Another mode of operation corresponds to licensed or unlicensed operation. For example, a WTRU may perform licensed carrier operation based on, responsive to and/or on condition that the WTRU receives and/or detects an SSB in a first sync raster set. The WTRU may perform unlicensed carrier operation when the WTRU receives and/or detects an SSB in a second sync raster set.

Another mode of operation corresponds to duplex mode (e.g., TDD or FDD).

In other implementations, one or more sync raster sets may be used and a WTRU may make various determinations based on the sync raster set in which the WTRU received, detected, or determined an SSB for initial access. For example, the WTRU may determine licensed spectrum or unlicensed spectrum, PBCH type (e.g., which information is included in the PBCH), and/or duplex mode (e.g., TDD, FDD, or half duplex (HD)-FDD). Alternatively, or additionally, the WTRU may determine a PRACH resource configuration and/or a range of the system bandwidth. Alternatively, or additionally, the WTRU may determine a use case (e.g., sidelink, Uu, non-terrestrial networks (NTN), etc.) and/or a maximum uplink transmission power. Alternatively, or additionally, the WTRU may determine barring of WTRU types (e.g., access barring of certain WTRU types). For example, a first type of WTRU (e.g., a WTRU with a limited capability including reduced Rx antenna, smaller maximum bandwidth supported, lower maximum transmission power) may not be allowed to access the cell based on, responsive to and/or on condition that the SSB is located in a first sync raster set. Otherwise, the first type of WTRU may be allowed to access the cell. Alternatively, or additionally, the WTRU may determine support of a specific functionality in the network (e.g., power saving, carrier aggregation, discontinuous reception (DRX), etc.).

### Mode of Operation Indication Based on Physical Cell ID

PCIDs may identify each NR cell to distinguish the cells in radio access networks. There are 1008 unique PCID given by PCID=3NID(1)+NID(2), where the parameter NID(1) is a value within a range of {0, 1, . . . , 335}, and the parameter NID(2) is a value within a range of {0,1,2}. The WTRU may acquire, define, configure, or determine a PCID based on a synchronization block (e.g., SS/PBCH block). The PSS may be associated with the NID(2), and the SSS may be associated with the NID(1) and the NID(2).

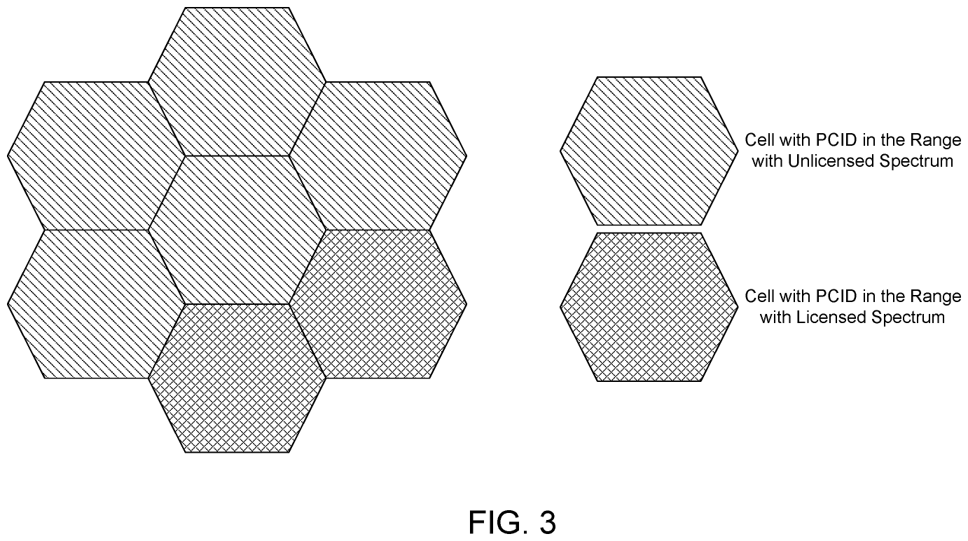

Referring to FIG. 3, the WTRU may acquire a mode of operation based on a value of a PCID when explicit signaling of the mode of operation is not present (provided, used, etc.). In some implementations, different ranges and thresholds may be used, defined, configured, or determined for the value of the PCID. In an example, two ranges of PCID values may be used, defined, or configured within a cellular network. While a value of a PCID is different and exclusive within each cell, the range that it falls within may indicate the mode of operation.

A threshold may be used, defined, configured, or determined, wherein a WTRU may determine a mode of operation based on a relative relation of values of the PCIDs to the threshold. For example, if a value of a PCID of a cell satisfies a threshold (e.g., the PCID>a threshold), the WTRU may determine that licensed spectrum operation is in use within that cell. In another example, if the value of a PCID of a cell fails to satisfy a threshold (e.g., the PCID<a threshold, the WTRU may determine that unlicensed spectrum operation is in use within that cell.

One or more ranges may be used, defined, configured, or determined, wherein a WTRU may determine a mode of operation based on a relative relation of values of the PCIDs to one or more ranges. For example, if a value of a PCID of a cell is within the ranges, the WTRU may determine that licensed spectrum operation is in use within that cell. In another example, if a value of a PCID of a cell is not within the ranges, the WTRU may determine that unlicensed spectrum operation is in use within that cell.

The WTRU may determine a license regime based on various criteria. For example, the WTRU may determine a license regime based on a property of PSS/SSS sequences detected. The property of the PSS/SSS sequences may be a PCID, an NID(1), and/or an NID(2) used for generating such sequences. Alternatively, or additionally, the WTRU may determine a license regime based on a subcarrier spacing value (or exponent thereof) used for generating and transmitting SS/PBCH block transmission. Alternatively, or additionally, the WTRU may determine a license regime based on a subcarrier spacing value (or exponent thereof) used for generating and transmitting a PDCCH transmission over a specific CORESET or search space, such as a type 0 search space. Alternatively, or additionally, the WTRU may determine a license regime based on a set of frequencies to which subcarriers belong (synchronization raster). Such a raster may be characterized by a subcarrier spacing and a synchronization raster offset. Alternatively, or additionally, the WTRU may determine a license regime based on detection of an additional signal (e.g., auxiliary signal). Such a signal may be generated in the same way as an existing synchronization signal but using parameters outside of the currently allowed space of parameters.

For example, license regimes may be associated with disjoint sets of parameters and/or properties, including one or more PCID values, one or more NID(1) values, one or more NID(2) values, one or more subcarrier spacing values, one or more synchronization raster offset values, one or more thresholds, etc. A WTRU may determine to which set of the sets a parameter or property belongs to and determine a corresponding license regime, e.g., based on, responsive to and/or on condition that the corresponding licensing regime is associated with/to the determined set. A set may be defined by at least one threshold T1, T2, etc. such that a first set corresponding to a first license regime includes all values between 0 and T1-1, a second set corresponding to a second license regime includes values between T1 and T2-1, and so on. A set may be defined by the result of a modulo operation with the divider corresponding to the number of license regimes. For example, in the case two license regimes are defined, odd values may correspond to a first license regime and even values may correspond to a second license regime. The number of regimes, the associated sets and parameters (e.g., T1, T2) may be pre-defined or pre-configured. Such information may be referred to as a “license regime configuration”.

### Mode of Operation Indication Based on Location and Zone ID

In some implementations, a WTRU may determine a license regime configuration and/or the license regime based on a geographical location. The WTRU may identify its geographic location based on a global navigation satellite system (GNSS), for example. The WTRU may determine an identity of a zone (“zone identity”) based on this geographic location and a pre-defined or pre-configured database. The WTRU may determine a corresponding license regime configuration based on a mapping between the zone identity, frequency band or carriers, and the license regime configuration. In case the WTRU cannot identify its geographical location, the WTRU may assume a default license regime configuration applicable to the frequency band.

### Mode of Operation Indication Based on Position and Settings of SIB1

In some implementations, a WTRU may identify one or more modes of operation based on the parameters indicated in a SIB1. The WTRU may identify the mode of operation, where the first mode may indicate the licensed spectrum operation, and the second mode may indicate the unlicensed spectrum operation.

A location of a SIB1 in time, a number of occupied symbols, a number of RBs, a frequency offset, a multiplexing pattern, and properties of the SIB1 may be used, defined, configured, or determined based on one or more MIB parameters. The MIB parameters are used to refer to setting tables, wherein the tables are different for the different modes of operation, e.g., licensed spectrum or unlicensed spectrum operation. For example, an IE controlResourceSetZero in a pdcch-ConfigSIB1 included in a MIB indicates a number of consecutive resource blocks, a number of consecutive symbols, a frequency offset, and a multiplexing pattern for a CORESET of a Type0 physical downlink control channel common search space (Type0-PDCCH CSS) set that refer to different reference tables for licensed and unlicensed band's channel access. In another example, an IE ssb-SubcarrierOffset corresponding to an IE k_{SSB} in a MIB, denotes a frequency domain offset of the SS/PBCH block, which is interpreted differently in licensed and unlicensed band regimes.

In some implementations, the WTRU may blindly detect a CORESET #0 and a Type0-PDCCH CSS based on a different interpretation of the MIB parameters, when explicit signaling of the CORESET #0 position is not present (provided, used, etc.) or cannot be decoded from the MIB. The WTRU may assume one mode of operation and decode the MIB based on settings and/or parameters associated with the assumed mode of operation. For example, the WTRU may select a first mode of operation and decode the MIB based on licensed spectrum operation. In such a case, the WTRU may decode the IE controlResourceSetZero in the IE pdcch-ConfigSIB1 included in the MIB based on licensed spectrum reference tables to determine the number of consecutive resource blocks, the number of consecutive symbols, the frequency offset, and the multiplexing pattern for the CORESET of the Type0-PDCCH CSS set. In an alternative or additional case, the WTRU may decode the IE ssb-SubcarrierOffset corresponding to an IE k_{SSB} in the MIB based on licensed spectrum to determine the frequency offset of the SS/PBCH block as well as the corresponding settings.

If detection of CORESET #0 based on the first mode of operation is unsuccessful, the WTRU may repeat the decoding of the MIB and the blind detection procedures assuming another mode of operation (e.g., for each repetition). For example, the WTRU may select a second mode of operation and decode the MIB based on unlicensed spectrum operation. In such a case, the WTRU may decode the IE controlResourceSetZero in the IE pdcch-ConfigSIB1 included in the MIB based on unlicensed spectrum reference tables to determine the number of consecutive resource blocks, the number of consecutive symbols, the frequency offset, and the multiplexing pattern for the CORESET of the Type0-PDCCH CSS set. In an alternative or additional case, the WTRU may decode the IE ssb-SubcarrierOffset corresponding to the IE k_{SSB} (which is a frequency domain offset between an SS/PBCH block and an overall resource block grid in number of subcarriers) in the MIB based on unlicensed spectrum to determine the frequency offset of the SS/PBCH block as well as the corresponding settings.

In some implementations, the WTRU may implicitly determine a mode of operation in the context of a license regime upon a successful detection of a position and properties of a CORESET #0 and a Type0-PDCCH CSS. For example, if the WTRU detects a CORESET #0 based on interpreting the MIB parameters according to the settings that correspond to the first mode of operation, the WTRU may identify licensed spectrum operation as the mode of operation. In another example, if the WTRU detects the CORESET #0 based on interpreting the MIB parameters according to the settings that correspond to the second mode of operation, the WTRU may identify unlicensed spectrum operation as the mode of operation.

### Explicit Identification of License Regime

In some implementations, a WTRU may receive one or more indications to determine whether to use a first mode of operation or a second mode of operation. The first mode of operation may be unlicensed band operation (e.g., for higher frequency such as above 52.6 GHz) and/or shared spectrum operation (e.g., for higher frequency such as above 52.6 GHz). For example, transmission power may be limited due to one or more regulations based on the frequency band and transmission bandwidth.

Alternatively, or additionally, the first mode of operation may be transmission and/or reception of channels and/or signals based on one or more channel assessment results of LBT procedures (e.g., for higher frequency such as above 52.6 GHz). For example, the WTRU may transmit and/or receive channels and/or signals based on the channel assessment results. If the channel assessment results are clear (e.g., indicate frequencies are not currently being used), then the WTRU may transmit and/or receive the channels and/or the signals. If the channel assessment results are not clear, then the WTRU may skip or postpone transmitting, and/or skip or postpone attempting to receive and/or receiving, the channels and/or the signals. In addition to omni beam based LBT procedures, beam based LBT procedures and/or receiver aided LBT procedures may additionally be supported by the WTRU and the gNB.

Alternatively, or additionally, the first mode of operation may be associated QCL assumptions between one or more SSBs (e.g., for higher frequency such as above 52.6 GHz). In such implementations, the WTRU may receive one or more of the SSBs assuming the one or more of the SSBs are quasi-co-located (QCLed). For example, the WTRU may receive an indication of a number of QCLed SSBs from a gNB (e.g., via a MIB). Based on the indication, the WTRU may assume that the one or more SSBs are QCLed. For example, SS/PBCH block index for unlicensed band may be redefined as:
SS/PBCH block index for licensed band mod the number of QCLed SSBs.

The second mode may involve various types of operation. For example, the second mode may correspond to licensed band operation and/or transmission and/or reception of channels and/or signals based on one or more configurations, activations, and/or indications of or sent from a base station (e.g., a gNB). In the latter case, the WTRU may transmit and/or receive channels and/or signals based on the configurations, activations, and/or indications of the base station. For example, the WTRU may receive one or more configurations of the channels and/or the signals for transmission and/or reception (e.g., via RRC). In another example, the WTRU may receive one or more activations and/or indications of the channels and/or the signals for transmission and/or reception (e.g., via MAC CE and/or DCI). Alternatively, or additionally, the second mode may correspond to transmission and/or reception of channels and/or signals without having to carry out LBT procedures and/or without having independent QCL assumptions between one or more SSBs.

In addition to the first mode and the second mode, a third mode may be additionally used for the determination. This third mode may correspond to unlicensed band operation (e.g., for frequency range (FR)1 and/or lower frequencies) and/or shared spectrum operation (e.g., for FR1 and/or lower frequencies). In the latter case, transmission power may be limited due to one or more regulations based on the frequency band and transmission bandwidth.

Alternatively, or additionally, the third mode may correspond to transmission and/or reception of channels and/or signals based on one or more channel assessment results of LBT procedures (e.g., for FR1 and/or lower frequencies). In this case, the WTRU may transmit and/or receive channels and/or signals based on the channel assessment results. For example, if the channel assessment results are clear, then the WTRU may transmit and/or receive the channels and/or the signals. If the channel assessment results are not clear, then the WTRU may skip or postpone transmitting, and/or skip or postpone attempting to receive and/or receiving, the channels and/or the signals.

Alternatively, or additionally, the third mode may correspond to associated QCL assumptions between one or more SSBs (e.g., for higher frequency such as above 52.6 GHz). Compared to the first mode, a relatively lower maximum number of QCLed SSBs may be used. For example, a first maximum number (e.g., 64) may be supported in the first mode, and a second maximum number (e.g., 8) may be supported in the third mode.

In some implementations, the WTRU may determine whether to receive the one or more indications based on various criteria. For example, the WTRU may determine whether to receive the one or more indications based on frequency range (FR). The WTRU may determine whether to receive the one or more indications based on an FR of WTRU operation. For example, if the WTRU is operating (e.g., transmission/reception) in a first FR (e.g., FR1 and/or FR2), the WTRU may determine to receive the one or more indications. If the WTRU is operating (e.g., transmission/reception) in a second FR (e.g., FR2 and/or FRx), the WTRU may determine not to receive the one or more indications.

Alternatively, or additionally, the WTRU may determine whether to receive the one or more indications based on an SCS (e.g., detected based on one or more SSBs). The WTRU may determine whether to receive the one or more indications based on a detected SCS of WTRU operation (e.g., detected by decoding one or more of the SSBs). If the WTRU detects a first SCS for its operation (e.g., by decoding one or more of the SSBs), the WTRU may determine to receive the one or more indications. Alternatively, or additionally, if the WTRU detects a second SCS for its operation (e.g., by decoding one or more of the SSBs), the WTRU may determine not to attempt to and/or receive the one or more indications.

Alternatively, or additionally, the WTRU may determine whether to receive the one or more indications based on a band. The WTRU may determine whether to receive the one or more indications based on a frequency band for WTRU operation. For example, if the WTRU is operating (e.g., carrying out transmission and/or reception) in a first frequency band, the WTRU may determine to receive the one or more indications. If the WTRU is operating (e.g., carrying out transmission and/or reception) in a second frequency band, the WTRU may determine not to receive the one or more indications.

Alternatively, or additionally, the WTRU may determine whether to receive the one or more indications based on a value of a PCID (e.g., detected based on one or more SSBs). The WTRU may determine whether to receive the one or more indications based on a detected value of a PCID of WTRU operation (e.g., detected by decoding one or more of the SSBs). For example, if the WTRU detects a value of a PCID to be within a first range of values for its operation (e.g., by decoding one or more of the SSBs), the WTRU may determine to receive the one or more indications. If the WTRU detects the value of the PCID to be within a second range of values for its operation (e.g., by decoding one or more of the SSBs), the WTRU may determine not to receive the one or more indications.

In some implementations, the WTRU may receive the one or more indications. Based on the received indications, the WTRU may identify whether to use the first mode or the second mode. For example, if 1 bit information in a decoded MIB indicates a first information (e.g., 0), the WTRU may determine the first mode of operation.

In some implementations, the WTRU may receive the one or more indications to determine whether to use the first mode or the second mode in various ways. For example, the WTRU may receive the one or more indications in MIB. In this case, the WTRU may receive the one or more indications based on decoding one or more PBCHs. Based on the decoded PBCH, the WTRU may identify whether to use the first mode or the second mode. The MIB based indication may be based on a reserved or repurposed bit. In the case of a reserved bit, one or more reserved bits (e.g., for licensed band or unlicensed band in FR1) may be used for the one or more indications. For example, 1 bit reserved information may be used as a reserved bit for licensed band or unlicensed band in FR1, but may be used as an indication for unlicensed band for higher frequencies.

In the case of a repurposed bit, the WTRU may receive the one or more indications based on one or more existing information fields (also referred to herein as IEs) in a MIB. For example, the one or more existing information fields may be an IE controlResourceSetZero in an IE pdcch-ConfigSIB1. All or part of the IE controlResourceSetZero may be for the one or more indications. For example, all or part of information (e.g., most significant bits (MSB) or least significant bits (LSB)) of the IE controlResourceSetZero may be used for the one or more indications. For example, if the information indicates a first information (e.g., 0), the WTRU may determine the first mode. If the information indicates a second information (e.g., 1) the WTRU may determine the second mode. In some implementations, reserved indexes in a table for a set of resource blocks and slots symbols of a CORESET for a Type0-PDCCH search space set may be used for the one or more indications.

Table 1 (below) lists indexes for (i) sets of resource blocks and slots symbols of CORESET for Type0-PDCCH search space set and (ii) the one or more indications (e.g., indexes 14 and 15).

TABLE 1

| | SS/PBCH | | | |
|---|---|---|---|---|
| | block and | | | |
| | CORESET | Number of | Number of | |
| | multiplexing | RBs | Symbols | |
| Index | pattern | N_{RB}^{CORESET} | N_{symb}^{CORESET} | Offset (RBs) |
| 0 | 1 | 24 | 2 | 0 |
| 1 | 1 | 24 | 2 | 4 |
| 2 | 1 | 48 | 1 | 14 |
| 3 | 1 | 48 | 2 | 14 |
| 4 | 3 | 24 | 2 | −20 if ^{k}_{SSB} = 0 |
| | | | | −21 if ^{k}_{SSB} > 0 |
| 5 | 3 | 24 | 2 | 24 |
| 6 | 3 | 48 | 2 | −20 if ^{k}_{SSB} = 0 |
| | | | | −21 if ^{k}_{SSB} > 0 |
| 7 | 3 | 48 | 2 | 48 |

| | |
|---|---|
| 8 | Reserved |
| 9 | Reserved |
| 10 | Reserved |
| 11 | Reserved |
| 12 | Reserved |
| 13 | Reserved |
| 14 | The first information (e.g., the first mode) |
| 15 | The second information (e.g., the second mode) |

Table 2 (below) lists indexes for sets of resource blocks and slots symbols of CORESET for Type0-PDCCH search space set, but does not include indexes for the one or more indications.

TABLE 2

| | SS/PBCH | | | |
|---|---|---|---|---|
| | block and | | | |
| | CORESET | Number of | Number of | |
| | multiplexing | RBs | Symbols | |
| Index | pattern | N_{RB}^{CORESET} | N_{symb}^{CORESET} | Offset (RBs) |
| 0 | 1 | 24 | 2 | 0 |
| 1 | 1 | 24 | 2 | 4 |
| 2 | 1 | 48 | 1 | 14 |
| 3 | 1 | 48 | 2 | 14 |
| 4 | 3 | 24 | 2 | −20 if ^{k}_{SSB} = 0 |
| | | | | −21 if ^{k}_{SSB} > 0 |
| 5 | 3 | 24 | 2 | 24 |
| 6 | 3 | 48 | 2 | −20 if ^{k}_{SSB} = 0 |
| | | | | −21 if ^{k}_{SSB} > 0 |
| 7 | 3 | 48 | 2 | 48 |

| | |
|---|---|
| 8 | Reserved |
| 9 | Reserved |
| 10 | Reserved |
| 11 | Reserved |
| 12 | Reserved |
| 13 | Reserved |
| 14 | Reserved |
| 15 | Reserved |

Alternatively, or additionally, the one or more existing information fields may be an IE subCarrierSpacingCommon. All or part of the IE sub CarrierSpacingCommon may be for the one or more indications. For example, all or part (e.g., MSB or LSB) of the IE sub Carrier Spacing Common may be used for the one or more indications. If the information indicates a first information (e.g., 0), the WTRU may determine the first mode. If the information indicates a second information (e.g., 1) the WTRU may determine the second mode.

Alternatively, or additionally, the one or more existing information fields may be an IE ssb-SubcarrierOffset. All or part of the IE ssb-SubcarrierOffset may be for the one or more indications. For example, all or part (e.g., MSB or LSB) of the IE ssb-SubcarrierOffset may be used for the one or more indications. For example, if the information indicates a first information (e.g., 0), the WTRU may determine the first mode. If the information indicates a second information (e.g., 1) the WTRU may determine the second mode.

Alternatively, or additionally, the one or more existing information fields may be an IE k_{SSB}. All or part of the IE k_{SSB} may be for the one or more indications. For example, all or part (e.g., MSB or LSB) of the IE k_{SSB} may be used for the one or more indications. For example, if the information indicates a first information (e.g., 0), the WTRU may determine the first mode. If the information indicates a second information (e.g., 1) the WTRU may determine the second mode.

Alternatively, or additionally, the one or more existing information fields may be an IE searchSpaceZero. All or part of the IE searchSpaceZero may be for the one or more indications. For example, all or part (e.g., MSB or LSB) of the IE searchSpaceZero may be used for the one or more indications. If the information indicates a first information (e.g., 0), the WTRU may determine the first mode. If the information indicates a second information (e.g., 1) the WTRU may determine the second mode.

Alternatively, or additionally, the one or more existing information fields may be an IE dmrs-TypeA-Position. All or part of the IE dmrs-TypeA-Position may be for the one or more indications. For example, all or part (e.g., MSB or LSB) of the IE dmrs-TypeA-Position may be used for the one or more indications. For example, if the information indicates a first information (e.g., 0), the WTRU may determine the first mode. If the information indicates a second information (e.g., 1) the WTRU may determine the second mode. If the IE dmrs-TypeA-Position is used for the one or more indications, additional DMRS positions may be predefined. For example, the WTRU may assume additional DMRS positions as 2 symbols (e.g., pos2) or 3 symbols (e.g., pos3).

Alternatively, or additionally, the WTRU may receive the one or more indications in one or more SIBs. The WTRU may receive the one or more indications based on decoding one or more of the SIBs. Based on the decoded SIBs, the WTRU may identify whether to use the first mode or the second mode.

Alternatively, or additionally, the WTRU may receive the one or more indications in one or more semi-static configurations. For example, the WTRU may receive the one or more indications based on one or more of the semi-static configurations (e.g., via RRC). Based on the one or more of the semi-static configurations, the WTRU may identify whether to use the first mode or the second mode.

Alternatively, or additionally, the WTRU may receive the one or more indications in one or more dynamic indications. For example, the WTRU may receive the one or more indications based on decoding one or more of the dynamic indications (e.g., via one or more MAC CEs and/or DCI). Based on the decoded SIBs, the WTRU may identify whether to use the first mode or the second mode. For the dynamic indication, the WTRU may receive activations (e.g., via one or more MAC CEs) of the semi-statically configured modes (e.g., configured via RRC communications). Based on the activations, the WTRU may receive (e.g., via DCI) the one or more indications of the activated modes.

### Preconfigured Locations of CORESET #0 in Consecutive Symbols

Hereafter, operation with or without shared spectrum channel access can be interchangeably used with unlicensed or licensed bands, respectively. Hereafter, SIB1 can be interchangeably used with CORESET #0 and/or Type0-PDCCH CSS.

A WTRU with the shared spectrum channel access operation may consider that, for initial access, SS/PBCH blocks are transmitted within a DBTW. A WTRU may determine patterns of the SS/PBCH block (“SS/PBCH block patterns”) within a DBTW based on an SCS of the SS/PBCH blocks. The WTRU may determine a multiplexing pattern, a number of consecutive resource blocks and a number of consecutive symbols for a CORESET of a Type0-PDCCH CSS set from an IE controlResourceSetZero in an IE pdcch-ConfigSIB1 included in a MIB. The WTRU may determine PDCCH monitoring occasions from an IE searchSpaceZero in the IE pdcch-ConfigSIB1 included in the MIB. The IE controlResourceSetZero and IE searchSpaceZero in the pdcch-ConfigSIB1, each may be four bits that indicate indexes to associated tables with corresponding settings.

In some implementations, for initial access operation with shared spectrum, the WTRU may be (pre)configured with a transmission of a CORESET #0 of a Type0-PDCCH from a base station (e.g., a gNB). As such, the WTRU may secure an occupancy of a transmission channel and ensure that a length (duration) of the gaps between transmissions within the DBTW are lower than sixteen microseconds (16 μs). For example, the WTRU may consider a multiplexing pattern for a SS/PBCH block and the CORESET #0 to be in a time-domain multiplexing pattern to ensure the channel occupancy, e.g., multiplexing pattern 1. In another example, the WTRU may determine a frequency offset, a number of RBs, a number of symbols, and/or multiplexing patterns of the CORESET #0 based on preconfigured settings. In another example, the WTRU may identify PDCCH monitoring occasions based on the preconfigured settings.

In case the WTRU is not preconfigured with a location and settings for a CORESET #0 and a Type0-PDCCH CSS, the WTRU may identify the location and the settings for the CORESET #0 and the Type0-PDCCH CSS based on an IE controlResourceSetZero and searchSpaceZero in an IE pdcch-ConfigSIB1 included in a MIB.

### Configuration/Activation and Indication of Pre-Configuration for CORESET #0 and Type0-PDCCH CSS

In some implementations, the WTRU may determine whether the location and/or settings of the CORESET #0 and Type0-PDCCH CSS are preconfigured based on an explicit indication. The WTRU may receive the indication through a parameter in a MIB. For example, when an IE controlResourceSetZero in an IE pdcch-ConfigSIB1 included in a MIB is within a range or higher than (or equal to) a value, the WTRU may determine that the pre-configuration for the CORESET #0 and the Type0-PDCCH CSS is activated. In another example, the WTRU may use the MSB of the IE controlResourceSetZero in the pdcch-ConfigSIB1 included in the MIB to determine the activation of the pre-configuration for the CORESET #0 and the Type0-PDCCH CSS. In another example, when IE k_{SSB} in an IE ssb-SubcarrierOffset in a MIB is within a range or higher than (or equal to) a value, the WTRU may determine that the pre-configuration for the CORESET #0 and the Type0-PDCCH CSS is activated. In another example, the WTRU may use the LSB of the IE k_{SSB} in the IE ssb-SubcarrierOffset in the MIB to determine the activation of the pre-configuration for the CORESET #0 and the Type0-PDCCH CSS.

### Pre-Configuration for CORESET #0 and Type0-PDCCH CSS Based on Reference SSB Patterns

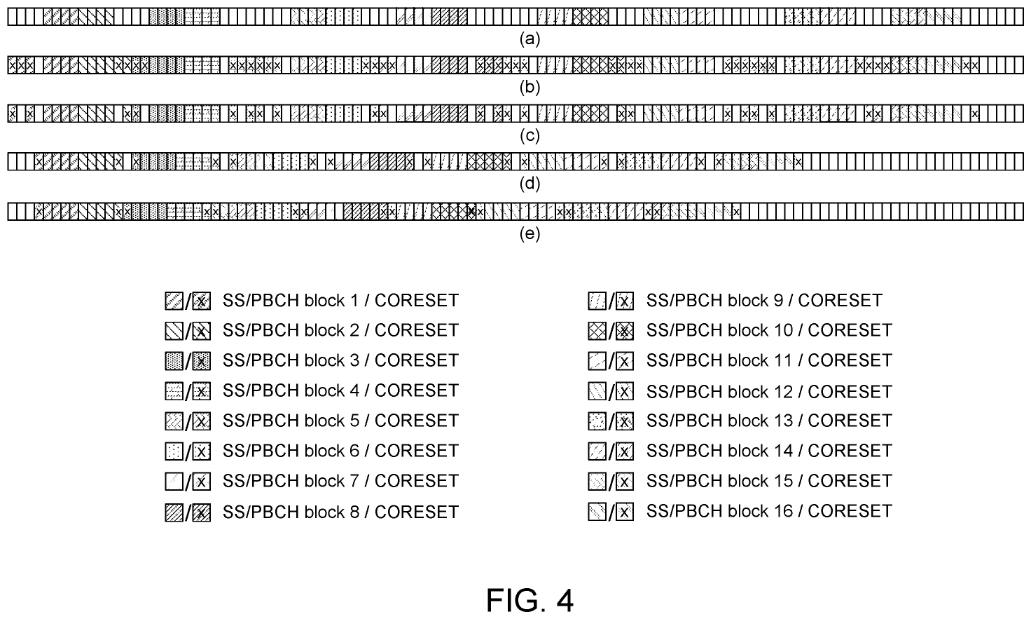

Referring to FIG. 4, a WTRU may be configured with a pre-configuration of a location and settings for a CORESET #0 and a Type0-PDCCH CSS based on reference SSB patterns (e.g., existing reference SSB patterns). As shown at FIG. 4(a), for Case D, an SCS of 120 kHZ is used, and candidate SS/PBCH blocks have respective sets of symbols, where the sets of symbols have respective first symbols at indexes {4, 8, 16, 20}+28*n_{Q}. Candidate positions for SS/PBCH blocks of sixteen different beams are shown using sixteen different hatch patterns in FIG. 4, and corresponding preconfigured CORESET #0 locations x are shown in FIGS. 4(b)-4(e) using the same hatch patterns to indicate the beams to which the respective CORESET #0 locations x correspond. For carrier frequencies larger than 6 GHz, n=0, 1, 2, 3, 5, 6, 7, 8, 10, 11, 12, 13, 15, 16, 17, 18. The following examples are provided for SS/PBCH blocks with SCS of 120 kHz, such as in Case D. Any other numerologies with any number of SS/PBCH beams may be used as well.

The WTRU may identify settings of a CORESET #0 based on various patterns. For example, as shown in FIG. 4(b), the WTRU may be configured with a CORESET #0 having a first multiplexing pattern (“multiplexing pattern 1”) and occurring in a maximum of three symbols (e.g., two or three symbols as shown) before or after corresponding SSB beams. The candidate locations for the CORESET #0 and the number of symbols can be identified, based on various criteria, for Case D reference SSB patterns with an SCS of 120 kHz. Examples of the identifying criteria include (i) a criterion that an SSB candidate that is associated with a CORESET #0 occurring in 3 symbols located before the corresponding SSB has an index: 4+28n; (ii) a criterion that an SSB candidate that is associated with a CORESET #0 occurring in 3 symbols located after the corresponding SSB has an index: 20+28n; (iii) a criterion that an SSB candidate that is associated with a CORESET #0 occurring in 2 symbols located before the corresponding SSB has an index: 16+28n; and (iv) a criterion that an SSB candidate that is associated with a CORESET #0 occurring in 2 symbols located after the corresponding SSB have an index: 8+28n_{Q}, where, n=0,1,2,3,5,6,7,8,10,11,12,13,15,16,17,18.

An alternative multiplexing pattern that the WTRU may use to identify the settings of a CORESET #0 is shown in in FIG. 4(c). The alternative multiplexing pattern is a variation of the multiplexing pattern 1 that is based on a CORESET #0 occurring in a maximum of two symbols (e.g., one or two symbols) before or after corresponding SSB beams. For example, the candidate locations for CORESET #0 and the number of symbols can be identified, based on various criteria, for Case D reference SSB patterns with an SCS of 120 kHz and multiplexing pattern 1. Example identifying criteria include (i) a criterion that an SSB candidate that is associated with a CORESET #0 occurring in 2 symbols located before the corresponding SSB has an index: 4+28n; (ii) a criterion that an SSB candidate associated with a CORESET #0 occurring in 2 symbols located after the corresponding SSB has an index: 20+28n; (iii) a criterion that an SSB candidate that is associated with a CORESET #0 occurring in 1 symbol located before the corresponding SSB has an index: 16+28n; and (iv) a criterion that an SSB candidate that is associated with a CORESET #0 occurring in 1 symbol located after the corresponding SSB has an index: 8+28n_{Q}, where, n=0,1,2,3,5,6,7,8,10,11,12,13,15,16,17,18.

In some implementations, the WTRU may identify and/or select any of the configured alternatives based on an explicit identification (e.g., based on MIB content). For example, the WTRU may use a searchSpaceZero in a pdcch-ConfigSIB1 that has been released due to the pre-configuration. In another example, a number of RBs, an offset of RBs, along with a selection between the alternatives can be selected based on an IE controlResourceSetZero in a IE pdcch-ConfigSIB1 in a MIB. In further examples, Table 3 shows the configurations to include the selection of alternatives.

TABLE 3
Set of resource blocks and slot symbols of CORESET#0
for TYPE0-PDCCH search space set in shared spectrum
when {SS/PBCH block, PDCCH} is {120, 120} kHz

| | | Number of | |
|---|---|---|---|
| | Number of | RBs | |
| Index | Symbols | N_{RB}^{CORESET} | Offset (RBs) |
| 0 | Alt. 1 | 24 | 0 |
| 1 | Alt. 1 | 24 | 4 |
| 2 | Alt. 1 | 48 | 14 |
| 3 | Alt. 2 | 24 | 0 |
| 4 | Alt. 2 | 24 | 4 |
| 5 | Alt. 2 | 48 | 14 |

| | |
|---|---|
| 6 | Reserved |
| 7 | Reserved |
| 8 | Reserved |
| 9 | Reserved |
| 10 | Reserved |
| 11 | Reserved |
| 12 | Reserved |
| 13 | Reserved |
| 14 | Reserved |
| 15 | Reserved |

In some implementations, the WTRU may not need to use some MIB content, since the WTRU receives (obtains) the locations, the number of symbols, and the multiplexing pattern of a CORESET #0 through preconfigured settings. The WTRU may identify the corresponding MIB content for other purposes. For example, an MSB of an IE controlResourceSetZero in an IE pdcch-ConfigSIB1 included in a MIB may be used to indicate a license regime of the bands. In another example, the IE controlResourceSetZero and/or IE searchSpaceZero in the pdcch-ConfigSIB1 included in the MIB may be used to indicate a beam index of the SS/PBCH blocks in a DBTW. In another example, the IE controlResourceSetZero and/or IE searchSpaceZero in the IE pdcch-ConfigSIB1 included in the MIB may be used to indicate a QCL relation of the SS/PBCH blocks in a DBTW.

### Pre-Configuration for CORESET #0 and Type0-PDCCH CSS Based on New SSB Patterns

In some implementations, the WTRU may determine (pre)configured location and settings of SS/PBCH block candidates based on a new SSB pattern different from existing reference SSB patterns. For example, the SS/PBCH block candidate locations may be (pre)configured in a duo SS/PBCH block set. The duo SS/PBCH block set may be (pre)configured such that two SS/PBCH beams are transmitted within the block set and in consecutive symbols. The duo SS/PBCH block set may include a corresponding CORESET #0, wherein the CORESET #0 may be (pre)configured to be located before and/or after the associated SS/PBCH block within the duo SS/PBCH block. For example, a single-symbol gap may be considered between the transmission of the SS/PBCH block and the corresponding CORESET #0 within the duo SS/PBCH block set. In another example, a no gap may be considered between the transmission of the SS/PBCH block and the corresponding CORESET #0 within the duo SS/PBCH block set. In another example shown in FIG. 4(d), a single-symbol gap may be considered between the transmission of the duo SS/PBCH block sets. In another example shown in FIG. 4(e), no gaps may be considered between the transmission of the duo SS/PBCH block sets.

Alternatively, rather than being (pre)configured in a duo SS/PBCH block set, the SS/PBCH block candidate locations may be (pre)configured in a SS/PBCH block set. Each SSB beam may be associated with the corresponding CORESET #0, wherein the CORESET #0 may be (pre)configured to be located before and/or after the SS/PBCH block. For example, a single-symbol gap may be considered between transmission of the SS/PBCH block and the corresponding CORESET #0 within the SS/PBCH block set. In another example, a no gap may be considered between transmission of the SS/PBCH block and the corresponding CORESET #0 within the SS/PBCH block set. In another example, a single-symbol gap may be considered between transmission of the different SS/PBCH block sets. In another example, no gaps may be considered between transmission of the different SS/PBCH block sets.

### Support of 64 Beams

In operation with shared spectrum channel access, the WTRU may assume that SS/PBCH blocks in a serving cell that are within a DBTW or across DBTWs are quasi co-located, if a value of (N_{DM-RS}^{PBCH} mod N_{SSB}^{QCL}) are the same among the SS/PBCH blocks. The WTRU may use (N_{DM-RS}^{PBCH} mod N_{SSB}^{QCL}) to determine an SS/PBCH block index within a DBTW. N_{DM-RS}^{PBCH} is an index of a DMRS sequence transmitted in a PBCH of a corresponding SS/PBCH block, and N_{SSB}^{QCL} is a parameter that may be defined as follows.

In some implementations, the WTRU may determine the N_{SSB}^{QCL} indicated explicitly from a MIB provided by a SS/PBCH block. For example, for 64 SS/PBCH beams, the WTRU may be configured with an indication based on two-bits including subsamples, e.g., in accordance with Table 4-(a), (b), and (c). The WTRU may determine the N_{SSB}^{QCL} based on a combination of various criteria. For example, one type of criteria corresponds to an IE subcarrierSpacingCommon and an LSB of an IE ssb-SubcarrierOffset in a MIB. Another type of criteria corresponds to the LSB of the IE ssb-SubcarrierOffset and an MSB of an IE controlResourceSetZero in a MIB. Another type of criteria corresponds to unused components from an IE controlResourceSetZero and/or an IE searchSpaceZero in a MIB, where the CORESET #0 location and/or settings are preconfigured.

In some implementations, for 64 SS/PBCH beams, the WTRU may be configured with an indication based on three-bits, e.g., in accordance with Table 5. The WTRU may determine the NQ based on the combination of various criteria. The WTRU may determine the N_{SSB}^{QCL} based on an LSB of an IE ssb-SubcarrierOffset, an MSB of an IE controlResourceSetZero and a single bit from unused components of the IE controlResourceSetZero or an IE searchSpaceZero in a MIB, where the CORESET #0 location and/or settings are preconfigured. Alternatively, or additionally, the WTRU may determine the N_{SSB}^{QCL} based on unused components from an IE controlResourceSetZero and/or an IE searchSpaceZero in a MIB, where the CORESET #0 location and/or settings are preconfigured.

TABLE 4
Mapping between the two-bits indication and N_{SSB}^{QCL}

| Index | N_{SSB}^{QCL} | Index | N_{SSB}^{QCL} | Index | N_{SSB}^{QCL} |
|---|---|---|---|---|---|
| 0 | 1 | 0 | 4 | 0 | 8 |
| 1 | 8 | 1 | 8 | 1 | 16 |
| 2 | 32 | 2 | 32 | 2 | 32 |
| 3 | 64 | 3 | 64 | 3 | 64 |

| | | |
|---|---|---|
| (a) | (b) | (c) |

TABLE 5
Mapping between the three-bits indication and N_{SSB}^{QCL}

| Index | N_{SSB}^{QCL} |
|---|---|
| 0 | 1 |
| 1 | 2 |
| 2 | 4 |
| 3 | 8 |
| 4 | 16 |
| 5 | 32 |
| 6 | 64 |
| 7 | reserved |

Indication of subcarrierSpacingCommon

In operation with shared spectrum channel access, a WTRU may assume that an SCS of a CORESET #0 for a Type0-PDCCH CSS set is the same or different from an SCS of the SS/PBCH block. In some implementations, the WTRU may determine the SCS of the CORESET for the Type0-PDCCH CSS set from among two possible SCS values (e.g., between 120 kHz and 960 kHz, or between 120 kHz and 480 kHz, or between 480 kHz and 960 kHz) based on a detected SCS for the SS/PBCH block and one bit in the MIB content. The WTRU may use an IE subcarrierSpacingCommon in a MIB to select between the two SCS for the CORESET #0 for the Type0-PDCCH CSS set. For example, if the WTRU acquires the MIB along with an SCS of 120 kHz for the SS/PBCH block, the selection of the SCS for the CORESET #0 for the Type0-PDCCH CSS set may be between 120 kHz and 960 kHz. In another example, if the WTRU acquires the MIB along with an SCS of 480 kHz for the SS/PBCH block, the selection of the SCS for the CORESET #0 for the Type0-PDCCH CSS set may be between 120 kHz and 480 kHz. In another example, if the WTRU acquires the MIB along with an SCS of 480 kHz for the SS/PBCH block, the selection of SCS for the CORESET #0 for the Type0-PDCCH CSS set may be between 480 kHz and 960 kHz. In another example, if the WTRU acquires the MIB along with an SCS of 960 kHz for the SS/PBCH block, the selection of an SCS for the CORESET #0 for the Type0-PDCCH CSS set may be between 480 kHz and 960 kHz.

In other implementations, a WTRU may determine an SCS of a CORESET for a Type0-PDCCH CSS set from among three possible SCS values (e.g., between 120 kHz, 480 kHz, and 960 kHz) based on a detected SCS for an SS/PBCH block and two bits in MIB content. In an example, the WTRU may determine the SCS of the CORESET #0 for the Type0-PDCCH CSS set from the values of 120 kHz, 480 kHz, and/or 960 kHz. The WTRU may use an IE subcarrierSpacingCommon in combination with another parameter in the MIB that may correspond to various types of parameters. The parameter(s) may be, for example, an LSB of an IE ssb-SubcarrierOffset in the MIB, an MSB of an IE controlResourceSetZero in the MIB, and/or unused components from the IE controlResourceSetZero and/or and IE searchSpaceZero in the MIB, where the CORESET #0 location and/or settings are preconfigured.

In other implementations, a WTRU may determine an SCS of a CORESET for a Type0-PDCCH CSS set from among three possible SCS values (e.g., 120 kHz, 480 kHz, and 960 kHz) based on a detected SCS for an SS/PBCH block and one bit in the MIB content. The WTRU may use an IE subcarrierSpacingCommon in the MIB to select among the three values for the SCS for the CORESET #0 for the Type0-PDCCH CSS set.

When using the IE subcarrierSpacingCommon in the MIB to select between three values for the SCS, the WTRU may consider two or more tables for determining the SCS for the CORESET #0 for the Type0-PDCCH CSS set. The WTRU may use a first table if the WTRU detects an first SCS for an SS/PBCH block and/or a second table if WTRU detects a second SCS for the SS/PBCH block. For example, the WTRU may use Table 6 (a), if the WTRU acquires an SS/PBCH block having an SCS of 120 kHz and/or 480 kHz. In another example, the WTRU may use Table 6 (b), if the WTRU acquires an SS/PBCH block having an SCS of 480 kHz and/or 960 kHz.

Alternatively, or additionally, when using an IE subcarrierSpacingCommon in a MIB to select between three values for the SCS, the WTRU may select between the three values for an SCS for a CORESET #0 for a Type0-PDCCH CSS set based on Table 7. For example, if the WTRU acquires the MIB along with an SCS of 120 kHz for the SS/PBCH block, the value scs120or960 (Table 7) corresponds to 120 kHz and the value scs480 (Table 7) corresponds to 480 kHz. In another example, if the WTRU acquires the MIB along with an SCS of 960 kHz for the SS/PBCH block, the value scs120or960 (Table 7) corresponds to 960 kHz and the value scs480 (Table 7) corresponds to 480 kHz. In another example, the WTRU may acquire the MIB based on detection of an additional signal (e.g., auxiliary signal). In another example, if the WTRU acquires the MIB along with an SCS of 480 kHz for the SS/PBCH block, the value scs120or960 (Table 7) corresponds to either 120 kHz or 960 kHz, and the value scs480 (Table 7) corresponds to 480 kHz.

In the case that the WTRU acquires the MIB along with the SCS of 480 kHz for the SS/PBCH block, the WTRU may implicitly determine an SCS configuration for the value of scs120or960 among the SCS of 120 kHz or 960 kHz based on various criteria. For example, one type of criteria may include a blind estimation of the SCS configuration. An alternative or additional criteria may include the (pre)configured location and settings for CORESET #0. In an example, WTRU may determine the SCS based on the number of symbols, number of RBs, and/or the offset of RBs configured for the CORESET #0.

TABLE 6
Mapping between the one-bit indication and SCS of CORESET#0

| | SCS of | | SCS of |
|---|---|---|---|
| Index value | CORESET#0 | Index value | CORESET#0 |
| 0 | 120 kHz | 0 | 480 kHz |
| 1 | 480 kHz | 1 | 960 kHz |

| | |
|---|---|
| (a) If the WTRU detects SSB | (b) If the WTRU detects SSB |
| with 120 kHZ and/or 480 kHz | with 480 kHZ and/or 960 kHz |

TABLE 7
Mapping between the one-bit indication and SCS of CORESET#0

| Index value | SCS of CORESET#0 |
|---|---|
| 0 | scs120or960 |
| 1 | scs480 |

Preconfigured Time and Frequency Locations of CORESET #0 and Type0-PDCCH CSS for the SSB with Non-Initial Access Use-Cases

Hereafter, the term SIB1 may be interchangeably used with the terms CORESET #0 and/or Type0-PDCCH CSS.

Hereafter, the term SSB based cell measurement may be interchangeably used with the terms SSB based measurement and/or cell measurement and/or synchronization signal (SS) reference signal receive power (SS-RSRP), SS reference signal receive quality (SS-RSRQ), SS signal to interference noise ratio (SS-SINR) measurement, and/or measurement.

Hereafter, the term SSB based intra-frequency cell measurement may be interchangeably used with the term single-numerology SSB based cell measurement, and the term SSB based inter-frequency cell measurement may be interchangeably used with the terms mixed-numerology SSB based cell measurement.

Cell reselection may be used to allow the WTRU to select and camp on a neighbor cell other than a serving cell. In an example, the WTRU may perform SS-RSRP, SS-RSRQ, and/or SS-SINR measurements of the serving cell and new cells, and may compare the results based on cell (re)selection criteria. Measurement reporting may be periodic, event triggered periodic, or event triggered. SSB based measurements of the new cells may be intra-frequency or inter-frequency measurements. An SSB based intra-frequency cell measurement may be defined where a center frequency of the SSB of the serving cell and the center frequency of the SSB of the neighbor/new cell are the same, and the subcarrier spacing of the two SSBs are also the same. Otherwise, the cell measurement may be defined as SSB based inter-frequency cell measurement.

The WTRU may be provided with a SSB based measurement timing configuration (SMTC) that identifies periodicity, duration, and offset information of a window of up to 5 ms to accomplish the measurements. The WTRU may be able to perform intra-frequency SSB based measurements without measurement gaps, e.g., if the corresponding SSB is completely located in the active BWP of the WTRU. While the intra-frequency SSB based measurements may be performed without measurement gaps, there are tighter restrictions for the no-gap inter-frequency SSB based measurements. As for the measurement gaps, based on 3GPP TS 38.133 v17.1.0, the gaps in SSB based inter-frequency measurements are in the order of 1.6 times higher than the gaps in SSB based intra-frequency measurements.

In an example, Tables 8 and 9 below include measurement periods (e.g., measurement gap repetition periods (MGRPs)) in FR1 for intra-frequency measurements and inter-frequency measurements with gaps, respectively. While the coefficients in the intra-frequency measurement gaps are on the order of 5, the peer coefficients for the inter-frequency measurement gaps are on the order of 8 (1.6 times higher).

TABLE 8
Measurement period for intra-frequency measurements with gaps (FR1)

| DRX cycle | T_{SSB}_measurement_period_intra |
|---|---|
| No DRX | max(200 ms, 5 × max(MGRP, |
| | SMTC period)) × CSSFᵢₙₜᵣₐ |
| DRX cycle ≤ 320 ms | max(200 ms, ceil(1.5 × 5) × max(MGRP, |
| | SMTC period, DRX cycle)) × CSSFᵢₙₜᵣₐ |
| DRX cycle > 320 ms | 5 × max(MGRP, DRX cycle) × CSSFᵢₙₜᵣₐ |

TABLE 9
Measurement period for inter-frequency
measurements with gaps (Frequency FR1)

| Condition ^{NOTE1,2} | T_{SSB}_measurement_period_inter |
|---|---|
| No DRX | Max(200 ms, 8 × Max(MGRP, SMTC |
| | period)) × CSSFᵢₙₜₑᵣ |
| DRX cycle ≤ 320 ms | Max(200 ms, Ceil(8 × 1.5) × Max(MGRP, |
| | SMTC period, DRX cycle)) × CSSFᵢₙₜₑᵣ |
| DRX cycle > 320 ms | 8 × DRX cycle × CSSFᵢₙₜₑᵣ |

In another example, Tables 10 and 11 below include measurement periods in FR2 for intra-frequency measurements and inter-frequency measurements with gaps, respectively. While the M_{meas_period with_gaps} in the intra-frequency measurement gaps are in the order of 40 samples for the WTRU supporting power class one or five, and 24 samples for the WTRU supporting other power classes, the peer coefficients are in the order of 64 samples and 40 samples for the inter-frequency measurement gaps, respectively (at least 1.6 times higher).

TABLE 10
Measurement period for intra-frequency
measurements with gaps (FR2)

| DRX cycle | T_{SSB}_measurement_period_intra |
|---|---|
| No DRX | max(400 ms, M_{meas period with gaps} × |
| | max(MGRP, SMTC period)) × CSSFᵢₙₜᵣₐ |
| DRX cycle ≤ 320 ms | max(400 ms, ceil(1.5 × Mₘₑₐₛ_period_with_gaps) × |
| | max(MGRP, SMTC period, |
| | DRX cycle)) ^{Note 1} × CSSFᵢₙₜᵣₐ |
| DRX cycle ≤ 320 ms | Mₘₑₐₛ_period with_gaps × max(MGRP, DRX cycle) × |
| | CSSFᵢₙₜᵣₐ |

TABLE 11
Measurement period for inter-frequency
measurements with gaps (Frequency FR2)

| Condition ^{NOTE1,2} | T_{SSB}_measurement_period_inter |
|---|---|
| No DRX | Max(400 ms, Mₘₑₐₛ_period_inter × |
| | Max(MGRP, SMTC period)) × CSSFᵢₙₜₑᵣ |
| DRX cycle ≤ 320 ms | Max(400 ms, (1.5 × Mₘₑₐₛ_period_inter) × |
| | Max(MGRP, SMTC period, DRX |
| | cycle)) × CSSFᵢₙₜₑᵣ |
| DRX cycle > 320 ms | M_{meas period inter} × DRX cycle × CSSFᵢₙₜₑᵣ |

There exists limitations on a number of cells and a number of the SSBs with different SSB indexes and/or PCIDs based on frequency range (FR) and for the intra-frequency and inter-frequency SSB based measurements. In an example, for the intra-frequency cell measurement in FR1, the WTRU shall support the number of the cells and the number of SSBs with different SSB indexes to be at least 8 and 14, respectively. For the intra-frequency cell measurement in FR2, the WTRU shall support the number of the cells and the number of SSBs with different SSB indexes and/or PCIDx to be at least 6 and 24, respectively. For the inter-frequency cell measurement in FR1, the WTRU shall support the number of the cells and the number of SSBs with different SSB indexes and/or PCIDs to be at least 4 and 7, respectively. For the inter-frequency cell measurement in FR2, the WTRU shall support the number of the cells and the number of SSBs with different SSB indexes and/or PCIDs to be at least 4 and 10, respectively.

An automatic neighbor cell relation (ANR) function may be used to manage an neighbor cell relation table (NCRT) without a burden of manually managing neighbor cell relations (NCRs). The ANR function may include various steps, e.g., as disclosed in 3GPP TS 38.300 v16.5.0. For example, the WTRU may be instructed to measure the neighbor cells and send a report including the PCIDs of the corresponding cells. As a next step, the WTRU may be requested to report broadcasted information of a neighbor NR cell that corresponds to one of the previously reported PCIDs. The WTRU may detect and decode a corresponding SS/PBCH block to find a configuration of the CORESET #0 and the Type-0 PDCCH. The WTRU may use the configurations to find an SIB1 to be able to find and report requested information. The broadcasted information may include one or more NR cell global identifiers (NCGI(s)) one or more EUTRA CGIs (ECGI(s)), TAC(s), RANAC(s), PLMN ID(s) and, for neighbor NR cells, NR frequency band(s).

The ANR function may be accomplished based on the intra-frequency or inter-frequency neighbor cell SSB based measurements. The measurement period required for acquiring and decoding an NR CGI in inter-frequency SSB based measurement is expected to be longer.

### SS/PBCH Block not Explicitly Indicating the Configuration for CORESET #0 and Type0-PDCCH CSS

For an SS/PBCH block in non-initial access use-cases, where the WTRU is explicitly configured with SSB location and SCS, transmitted SS/PBCH blocks may be configured to not include configurations of time and frequency allocation of a CORESET #0 and/or a Type-0 PDCCH. The WTRU has to switch from an active BWP to ab initial BWP to detect and decode the SS/PBCH block for initial access in order to find the configurations corresponding to the CORESET #0 and/or he Type-0 PDCCH to be able to access the information transmitted in a SIB1. For example, the WTRU may be in CONNECTED mode or IDLE/Inactive mode. In another example, the numerology/SCS of a SS/PBCH block in an active BWP may be different from an SCS of an SS/PBCH block in an initial BWP. For instance, the SCS of the SS/PBCH block in the active BWP may be 480 kHz or 960 kHz, where the SCE of the SS/PBCH block in the initial BWP may be 120 kHz.

### Configuration/Activation and Indication of (Pre)Configuration for CORESET #0 and Type0-PDCCH CSS

In an implementation, for SS/PBCH block measurement where a transmitted SS/PBCH block does not include configuration of a CORESET #0 and/or a Type-0 PDCCH, the WTRU may be (pre)configured with the location and settings of the transmission of CORESET #0 of the Type0-PDCCH. The WTRU may access the CORESET #0, Type-0 PDCCH, and SIB1 while remaining on its active BWP and operating on a single numerology. The WTRU may not need to switch to an initial BWP and/or switch to mixed numerology operation. For example, the WTRU may determine one or more of a frequency offset, a number of RBs, a number of symbols, and/or multiplexing patterns of the CORESET #0 based on the (pre)configured settings. Alternatively, or additionally, the WTRU may identify the Type0-PDCCH monitoring occasions based on the (pre)configured settings.

In an implementation, for SS/PBCH block measurement where a transmitted SS/PBCH block does not include configuration of a CORESET #0 and/or a Type-0 PDCCH CSS, the WTRU may follow one or more steps. For example, the WTRU may verify if the corresponding SS/PBCH block is associated with the (pre)configuration of the settings for the CORESET #0 and/or the Type-0 PDCCH CSS. Additionally, in case the WTRU is not preconfigured with location and settings for the CORESET #0 and the Type0-PDCCH CSS, the WTRU may identify location and settings for the CORESET #0 and the Type0-PDCCH CSS based on an IE controlResourceSetZero and an IE searchSpaceZero in an IE pdcch-ConfigSIB1, included in a MIB in the SS/PBCH block for initial access at an initial BWP. Also, in case the (pre)configuration is enabled (e.g., based on a configuration or an indication via one or more of a MIB, a SIB, RRC communication, MAC CE communication, and DCI communication from a serving cell), the WTRU may determine the (pre)configured settings for the CORESET #0 and/or the Type-0 PDCCH CSS. The WTRU may determine one or more of a frequency offset, a number of RBs, a number of symbols and/or multiplexing patterns of the CORESET #0 and/or the Type-0 PDCCH CSS based on the (pre)configured settings. The WTRU may access the SIB1 (e.g., SIB1 of other cells for monitoring) based on the information derived from the Type-0 PDCCH.

### Verification of the (Pre)Configuration for CORESET #0 and Type0-PDCCH CSS]

In an implementation, for SS/PBCH block measurement where a transmitted SS/PBCH block does not include a configuration of a CORESET #0 and/or a Type-0 PDCCH, the WTRU may determine if a corresponding SS/PBCH block is associated with the (pre)configured settings based on various criteria. For example, the WTRU may receive an enable flag and/or disable flag for the (pre)configured settings based on parameters included in a MIB in the SS/PBCH block. In one such scenario, every other SS/PBCH block may include an indication to the enable/disable flag for the (pre)configured settings based on the parameters included in the MIB in the SS/PBCH block. Additionally, the WTRU may identify that the (pre)configuration of the settings are enabled/disabled based on the IE k_{SSB} in an IE ssb-SubcarrierOffset. In one such scenario, a specific value or a range of values in the IE k_{SSB} in the IE ssb-SubcarrierOffset may determine if the (pre)configuration of the settings are enabled/disabled. The WTRU may identify the (pre)configuration of the settings are enabled/disabled based on one or more fields, such as an IE subcarrierSpacingCommon, a MSB of an IE controlResourceSetZero in the MIB, unused components from an IE controlResourceSetZero, and/or an IE searchSpaceZero in the MIB, where the CORESET #0 location and/or settings are preconfigured for a serving cell. Further, the WTRU may determine the enabled/disabled (pre)configuration of the settings based on an IE controlResourceSetZero and/or am IE searchSpaceZero in an IE pdcch-ConfigSIB1. In one such scenario, a specific value or a range of values in either of the parameters may determine if the (pre)configuration of the settings are enabled/disabled. The WTRU may determine the enabled/disabled (pre)configuration of the settings based on a configured SCS of SS/PBCH blocks for non-initial access. In one such scenario, if the configured SCS is identical to a SCS of the WTRU operation in the serving cell, the WTRU may determine that (pre)configuration of the settings is enabled; if not, the WTRU may determine that (pre)configuration of the setting is disabled. The WTRU may determine the enabled/disabled (pre)configuration of the settings based on a location of SS/PBCH blocks for non-initial access. In one such scenario, if the configured location is a first position, the WTRU may determine that (pre)configuration of the settings is enabled; and, if the configured location is a second position, the WTRU may determine that (pre)configuration of the setting is disabled.

In another implementation, the WTRU may receive the enabled/disabled flag for the (pre)configured settings based on the one or more configurations, activations, and/or indications of or sent from a base station (e.g., a gNB). For example, the WTRU may receive one or more configurations via RRC, MAC CE, and/or DCI. The indication may be based on explicitly indicating enable/disabled (e.g., 0 for disabled and 1 for disabled or toggling a field (e.g., 0→1 and 1→0 for enabled, 0→0 and 1→1 for disabled).

### Determination of the (Pre)Configuration for CORESET #0 and Type0-PDCCH CSS

In an implementation, the WTRU may determine the (pre)configuration of a CORESET #0 and/or a Type-0 PDCCH in one or more ways. For example, the WTRU may receive the (pre)configured settings based on the one or more configurations, activations, and/or indications of or sent from a base station (e.g., a gNB). In some scenarios, the WTRU may receive one or more configurations via RRC, MAC CE, and/or DCI. In one such scenario, the WTRU may receive explicit configurations for one or more of a frequency offset, a number of RBs, a number of symbols, and/or multiplexing patterns of a CORESET #0. In another such scenario, the WTRU may receive relative offsets from the configurations of a serving cell. For instance, the WTRU may receive one or more of a relative frequency offset, a difference between number of RBs in a serving cell and a cell for (pre)configuration, a difference between number of symbols in a serving cell and a cell for (pre)configuration, and/or a difference between multiplexing patterns of the CORESET #0 (e.g., 0→identical with the serving cell and 1→application of different multiplexing patterns). Alternatively, or additionally, the WTRU may determine the (pre)configured settings based on one or more of a carrier frequency, a carrier bandwidth, and/or an SCS. For instance, the WTRU may determine time and frequency allocation settings for the CORESET #0 and the Type0-PDCCH CSS according to a table and based on its active BWP and an SCS of a SS/PBCH block. Alternatively, or additionally, the WTRU may use one or more settings of a serving cell for the (pre)configured settings. For instance, the WTRU may determine to use one or more of configured parameters (e.g., one or more of the frequency offset, number of RBs, number of symbols and/or multiplexing patterns of the CORESET #0) of the serving cell as the (pre)configured settings.

Mode of Operation Indication and/or Parameter Indication Based on a DMRS in PBCH

### DMRS Sequence in PBCH

A WTRU may receive PBCH transmission. The WTRU may receive a DMRS to use as a reference for carrying out demodulation of the PBCH transmission. The DMRS sequence may be transmitted and/or received in time and frequency resources the respective PBCH. The term PBCH DMRS may be used to represent the content, information, payload and/or reference signal transmitted in respective PBCH.

The PBCH DMRS may be part of an SSB. The SSB may have an SSB index (ι̅). One or more SSBs may be transmitted where each SSB may have an SSB index. In an example, up to 64 SSBs may be transmitted in an SSB burst, where 6 bits are used to indicate the candidate SSB indexes.

The PBCH DMRS may be a reference sequence. For example, the PBCH DMRS may be generated based on (e.g., using) a pseudo-random sequence. A scrambling sequence generator used to generate the sequence corresponding to PBCH DMRS may be initialized and/or configured based on a cell index (N_{ID}^{CELL}) and a candidate SSB index (ι̅). In an example, the term ι̅_{SSB}=i_{SSB} may be used as the index for the PBCH DMRS employed as an input parameter to the scrambling sequence generator, where i_{SSB} is the three least significant bits of the candidate SSB index. In an example, the scrambling sequence generator may be initialized based on equation 1 below:

cᵢₙᵢₜ=2¹¹(ι̅_{SSB}+1)(└N_{ID}^{cell}/4┘+1)+2⁶(ι̅_{SSB}+1)+(N_{ID}^{cell} mod 4) Eq. (1)

The equation 1 is a non-limiting example of the parameters that may be used to determine the initialization value of a PBCH DMRS sequence. One or more of those parameters may be included. The coefficients and choices for each parameter are examples. Other coefficients or choices may be included.

The candidate SSB index (ι̅) may be indicated based on a first set of bits, and a second set of bits, and so forth. The first set of bits may be L LSBs to determine the SSB index. The second set of bits may be M MSBs to determine the SSB index. The first set of bits may be determined based on an index of the DMRS sequence transmitted in the PBCH. For example, the three LSB bits of a candidate SSB index may be determined based on the index used in generation of the DMRS sequence transmitted in the PBCH.

### QCL Relation of SSBs

A WTRU may receive an SSB. The SSB may be part of an SSB burst transmission. In operation with shared spectrum channel access, a WTRU may be configured to receive the SSBs within a same DBTW or across multiple DBTWs. The WTRU may determine that SSBs within a same DBTW or across DBTWs are quasi co-located. In an example, if the value of (ι̅ mod N_{SSB}^{QCL}) is the same for two or more SSBs, the WTRU may determine that the respective SSB beams are quasi co-located, wherein 1 indicates the candidate SSB index.

The WTRU may receive the parameter N_{SSB}^{QCL} or Q parameter as part of a MIB in a PBCH. The terms N_{SSB}^{QCL} and Q parameter may be used interchangeably herein. In an example, the Q parameter may be determined based on one or more bits in the MIB in the PBCH. In another example, the Q parameter may be determined based on combination of one or more parameters in the MIB that are repurposed in operation with shared spectrum channel access.

When operating in high frequencies, the licensed and unlicensed bands may overlap in some regions. In operation with shared spectrum, more candidate Q parameters may be used for QCL relations indication and/or implicit/explicit indication of license regime. As a result, more bits may be needed for the indication of parameters, e.g., Q parameter, license regime, LBT enable/disable, candidate SSB indexes, and so forth.

In various embodiments, one or more PBCH DMRS sets may be used, defined, configured, and/or determined. The PBCH DMRS sets may be configured as part of SSB configuration, for example. Any PBCH DMRS set of the PBCH DMRS sets may be mutually exclusive to any other PBCH DMRS set of the PBCH DMRS sets.

One or more indexes may be determined for each (or any) PBCH DMRS set of the PBCH DMRS sets. For example, the indexes may be determined based on equation 2 below:

ι̅_{SSB}=i_{SSB}+rn_{Q}, Eq. (2)

where i_{SSB} may be a value indicated by the three LSB of a candidate SSB index, i.e., 0≤i_{SSB}≤7, n_{Q} may be a weighting factor and r may be a factor indicating an offset. The weighting factor n_{Q} and the factor r collectively rn_{Q} may be referred to as an offset component The factor r may indicate, for example, a starting offset or another offset to another reference. In various embodiments, the factor r may be, for example, r=2^{m}, m≥3. The weighting factor n_{Q} may be equal to one (i.e., n_{Q}=1). Alternatively, the weighting factor n_{Q} may be equal to zero (i.e., n_{Q}=0). In various embodiments, the weighting factor n_{Q} being n_{Q}=0 (e.g., determined to be equal to zero by a WTRU and/or a base station), may indicate operation without shared spectrum channel access (e.g., licensed, non-shared spectrum operation and/or operation without LBT). In various embodiments, the weighting factor n_{Q} being n_{Q}=1 (e.g., determined to be equal to one by a WTRU and/or a base station) may indicate operation with shared spectrum channel access (e.g., unlicensed, shared spectrum operation and/or operation with LBT). In various embodiments, the weighting factor n_{Q} may be equal to a number other than zero or one.

One or more candidate values for the factor r (“candidate factor r values”) may be determined. The candidate factor r values may be based on any of a frequency range, a license regime, a Q parameter, a number (e.g., a maximum number) of SSBs within an SSB burst, one or more LBT requirements (criteria), etc. In various embodiments, a WTRU may determine the candidate factor r values based on an association (e.g., a predefined association) between one or more of the above information and a set of candidate factor r values. The association may be implemented as one or more rules, for example. The rules may be predefined and/or previously configured. As an example, when the WTRU receives configuration information for, and/or an indication of, any of the above information, then the WTRU can/may determine the candidate factor r values based on the association between the above information and a set of candidate factor r values.

In various embodiments, a WTRU may determine the candidate factor r values based on associations (e.g., a predefined associations) between frequency ranges and sets of candidate factor r values. By way of example, the associations may include, for example, first, second and third associations. The first association may be between a first of the frequency ranges and a first set of values, ranges, and/or thresholds for factor r (e.g., in line with the example above, for the first frequency range, the term m in factor r=2^{m} may be 3 (i.e., m=3)). The second association may be between a second of the frequency ranges and a second set of values, ranges, and/or thresholds for factor r (e.g., in line with the example above, for the second frequency range, the term m in factor r=2^{m} may be 3 and 4 (i.e., m=3, 4)). The third association may be between a third of the frequency ranges and a third set of values, ranges, and/or thresholds for factor r (e.g., in line with the example above, for the third frequency range, the term m in factor r=2^{m} may be 3, 4, 5 and 6 (i.e., m=3, 4, 5, 6)). When the WTRU receives configuration information for configuring operation in the first frequency range and/or the WTRU performs initial access in the first frequency range, then the WTRU may determine the candidate factor r values based on the association between the first frequency range and the first set of values, ranges, and/or thresholds for factor r. Alternatively, and/or additionally, when the WTRU receives configuration information for configuring operation in the second frequency range and/or the WTRU performs initial access in the second frequency range, then the WTRU may determine the candidate factor r values based on the association between the second frequency range and the second set of values, ranges, and/or thresholds for factor r. Alternatively, and/or additionally, when the WTRU receives configuration information for configuring operation in the third frequency range and/or the WTRU performs initial access in the third frequency range, then the WTRU may determine the candidate factor r values based on the association between the third frequency range and the third set of values, ranges, and/or thresholds for factor r. In various embodiments, the first, second and third frequency ranges may be mutually exclusive frequency ranges. Three associations are described for example purposes only. The associations may include more or fewer than three associations.

In various embodiments, a WTRU may determine the candidate factor r values based on associations (e.g., a predefined associations) between license regimes and sets of candidate factor r values. When the WTRU receives configuration information indicating one of the license regimes or the WTRU does initial access in one of license regimes, then the WTRU can/may determine the candidate factor r values based on the corresponding association. By way of example, the associations may include, for example, first, second and third associations. The first association may be between a first of the license regimes and a first set of values, ranges, and/or thresholds for factor r. The second association may be between a second of the license regimes and a second set of values, ranges, and/or thresholds for factor r. When the WTRU receives configuration information for configuring operation in the first license regime and/or the WTRU performs initial access in the first license regime, then the WTRU may determine the candidate factor r values based on the association between the first license regime and the first set of values, ranges, and/or thresholds for factor r. Alternatively, and/or additionally, when the WTRU receives configuration information for configuring operation in the second license regime and/or the WTRU performs initial access in the second license regime, then the WTRU may determine the candidate factor r values based on the association between the second license regime and the second set of values, ranges, and/or thresholds for factor r. In various embodiments, different values of factor r may be determined for licensed spectrum, unlicensed spectrum, license exempt spectrum, and/or lightly licensed spectrum (e.g., as different ones of the license regimes). Two associations are described for example purposes only. The associations may include more or fewer than two associations.

In various embodiments, a WTRU may determine the candidate factor r values based on associations (e.g., a predefined associations) between Q parameters and sets of candidate factor r values. When the WTRU receives configuration information indicating one of the Q parameters, then the WTRU can/may determine the candidate factor r values based on the corresponding association. By way of example, the associations may include, for example, first and second associations. The first association may be between a first of the Q parameters and a first set of values, ranges, and or thresholds for factor r. The second association may be between a second of the Q parameters and a second set of values, ranges, or thresholds for factor r. When the WTRU receives configuration information for configuring operation with the first Q parameter and/or the WTRU receives an indication to use the first Q parameter, then the WTRU may determine the candidate factor r values based on the association between the first Q parameter and the first set of values, ranges, and/or thresholds for factor r. Alternatively, and/or additionally, when the WTRU receives configuration information for configuring operation with the second Q parameter and/or the WTRU receives an indication to use the second Q parameter, then the WTRU may determine the candidate factor r values based on the association between the second Q parameter and the second set of values, ranges, and/or thresholds for factor r. Two associations are described for example purposes only. The associations may include more or fewer than two associations.

In various embodiments, a WTRU may determine the candidate factor r values based on associations (e.g., a predefined associations) between maximum numbers of SSBs within an SSB burst and sets of candidate factor r values. When the WTRU receives configuration information indicating one of the maximum numbers of SSBs, then the WTRU can/may determine the candidate factor r values based on the corresponding association. By way of example, the associations may include, for example, first and second associations. The first association may be between a first of the maximum numbers of SSBs and a first set of values, ranges, and/or thresholds for factor r. The second association may be between a second of the maximum numbers of SSBs and a second set of values, ranges, or thresholds for factor r. When the WTRU receives configuration information for configuring operation with the first maximum number of SSBs and/or the WTRU receives an indication to use the first maximum number of SSBs, then the WTRU may determine the candidate factor r values based on the association between the first maximum number of SSBs and the first set of values, ranges, and/or thresholds for factor r. Alternatively, and/or additionally, when the WTRU receives configuration information for configuring operation with the second maximum number of SSBs and/or the WTRU receives an indication to use the second maximum number of SSBs, then the WTRU may determine the candidate factor r values based on the association between the second maximum number of SSBs and the second set of values, ranges, and/or thresholds for factor r. Two associations are described for example purposes only. The associations may include more or fewer than two associations.

In various embodiments, a WTRU may determine the candidate factor r values based on associations (e.g., a predefined associations) between LBT requirements/criteria and sets of candidate factor r values. When the WTRU receives configuration information indicating one of the LBT requirements/criteria, then the WTRU can determine the candidate factor r values based on the corresponding association. By way of example, the associations may include, for example, first, second and third associations. The first association may be between a first of the LBT requirements/criteria (e.g., LBT is enabled) and a first set of values, ranges, and or thresholds for factor r. The second association may be between a second of the LBT requirements/criteria (e.g., LBT is not enabled) and a second set of values, ranges, or thresholds for factor r. The third association may be between a third of the LBT requirements/criteria (e.g., LBT is exempted (e.g., due to short control signaling) and a third set of values, ranges, or thresholds for factor r. When the WTRU receives configuration information for configuring operation with the first of the LBT requirements/criteria (e.g., LBT is enabled) and/or the WTRU receives an indication to use the first of the LBT requirements/criteria, then the WTRU may determine the candidate factor r values based on the association between the first of the LBT requirements/criteria and the first set of values, ranges, and/or thresholds for factor r. Alternatively, and/or additionally, when the WTRU receives configuration information for configuring operation with the second of the LBT requirements/criteria (e.g., LBT is not enabled) and/or the WTRU receives an indication to use the second of the LBT requirements/criteria, then the WTRU may determine the candidate factor r values based on the association between the second of the LBT requirements/criteria and the second set of values, ranges, and/or thresholds for factor r. Alternatively, and/or additionally, when the WTRU receives configuration information for configuring operation with the third of the LBT requirements/criteria (e.g., LBT is exempted) and/or the WTRU receives an indication to use the third of the LBT requirements/criteria, then the WTRU may determine the candidate factor r values based on the association between the third of the LBT requirements/criteria and the third set of values, ranges, and/or thresholds for factor r. Three associations are described for example purposes only. The associations may include more or fewer than three associations.

In various embodiments, one or more candidate indexes may be determined for each (any) PBCH DMRS set of one or more PBCH DMRS sets based on candidate step sizes and/or candidate offsets (e.g., candidate starting offsets). For example, the candidate step sizes may be, for example, 0≤i_{SSB}≤7, and the candidate offsets may be based on values of the weighting factor n_{Q} and values of the factor r. For example, a WTRU may determine 0≤i_{SSB}≤7 by assuming (e.g., setting) the weighting factor n_{Q} is equal to zero (i.e., n_{Q}=0) for a first PBCH DMRS set of the PBCH DMRS sets. Alternatively, and/or additionally, the WTRU may determine 8≤ι̅_{SSB}≤15 by assuming (e.g., setting) the weighting factor n_{Q} is equal to one (i.e., n_{Q}=1) and the factor r is equal to 2³ (i.e., r=2³) for a second PBCH DMRS set of the PBCH DMRS sets. Alternatively, and/or additionally, the WTRU may determine 16≤ι̅_{SSB}≤2³ by assuming (e.g., setting) the weighting factor n_{Q} is equal to one (i.e., n_{Q}=1) and the factor r is equal to 2³ (i.e., r=2⁴) for a third PBCH DMRS set of the PBCH DMRS sets.

In various embodiments, one or more of PBCH DMRS sets may be used and each PBCH DMRS set may be associated with a mode of operation. One or more of the following may apply.

A WTRU may receive one or more transmissions including an SSB. The WTRU may determine, obtain, extract, etc., one or more parameters from the SSB, e.g., one or more parts and/or components of the SSB, such as a PSS and/or an SSS. The parameters may include, e.g., a cell ID (N_{ID}^{cell}) and i_{SSB}.

The WTRU may determine possible candidate values for the weighting factor n_{Q}, the factor r and i_{SSB} for each of one or more candidate PBCH DMRS sets.

The WTRU may determine a candidate step size and a candidate offset (e.g., starting offset) of each (any) of the one or more indexes in the PBCH DMRS sets, e.g., based on the candidate values of i_{SSB}, the candidate values of the factor r, and the candidate values of the weighting factor n_{Q}.

The WTRU may determine one or more candidate index values, e.g., ι̅_{SSB}, for each candidate PBCH DMRS set. For example, the WTRU may calculate the candidate indexes, e.g., ι̅_{SSB}, using equation 2 and the candidate step sizes and candidate offsets.

The WTRU may determine one or more initialization values, e.g., cᵢₙᵢₜ. The WTRU may determine a candidate DMRS sequence associated with each initialization value of the initialization values for each candidate PBCH DMRS set.

The WTRU may determine one or more PBCH DMRS sets of the candidate PBCH DMRS sets by detecting/determining one or more DMRS sequences, of the determined candidate DMRS sequences, associated with the one or more PBCH DMRS sets.

The WTRU may determine the parameters associated with the determined one or more PBCH DMRS sets. For example, the WTRU may determine the DMRS index, i.e., ι̅_{SSB}, in the respective PBCH and may determine the corresponding values of the factor r and the weighting factor n_{Q}.

The WTRU may determine and/or perform one or more modes of operation based on the determined parameters. The WTRU, for example, may determine a mode of operation and/or perform that mode of operation (or in accordance with that mode) based on an association between the mode of operation the determined parameters. By way of example, a first of the modes of operation (e.g., licensed, non-shared spectrum operation and/or operation without LBT) may be associated with first determined parameters, and a second of the modes of operation (e.g., unlicensed, shared spectrum operation and/or operation with LBT) may be associated with and second determined parameters. The WTRU may determine the first mode of operation and/or perform the first mode of operation (or in accordance with the first mode) when (responsive to) determining the first determined parameters. Alternatively, and/or additionally, The WTRU may determine the second mode of operation and/or perform the second mode of operation (or in accordance with the second mode) when (responsive to) determining the second determined parameters. The terms “when”, “responsive to”, “after” and “in connection with” may be used interchangeably herein.

The WTRU may determine the three LSB bits of the candidate SSB index based on equation 3 below:

i_{SSB}=(ι̅_{SSB} mod r) Eq. (3)

where the factor r is one of the determined parameters.

The WTRU may obtain and/or may determine the remaining bits of the candidate SSB index. The UE may perform one or more operations based on the candidate SSB index, including reporting the candidate SSB index to the network (e.g., base station), making and/or configuring for various measurements, determining PRACH resources, etc.

The modes of operation may include and/or be based on any of a license regime, a Q parameter, a number (e.g., a maximum number) of candidate SSB positions, a DBTW, PBCH reception, a SSB configuration, CORESET #0 and Type-0 PDCCH search space monitoring, a sensing before transmission, duplex mode, etc.

In various embodiments, a WTRU may determine a DMRS received in a PBCH is in a first PBCH DMRS set, and may determine the license regime in a first mode of operation based on, responsive to and/or on condition that the DMRS received in the PBCH is in the first PBCH DMRS set. Alternatively, and/or additionally, the WTRU may determine a DMRS received in a PBCH is in a second PBCH DMRS set, and may determine the license regime in a second mode of operation based on, responsive to and/or on condition that the DMRS received in the PBCH is in the second PBCH DMRS set. In various embodiments, the channel access operation may be determined based on the license regime. For example, a WTRU may perform channel access without shared spectrum operation if the spectrum is licensed (e.g., n_{Q}=0). Alternatively, and/or additionally, the WTRU may perform channel access with shared spectrum operation if the spectrum is unlicensed (e.g., n_{Q}=1).

In various embodiments, a WTRU may determine that a DMRS received in a PBCH is in a first PBCH DMRS set, and may determine a first value for the Q parameter based on, responsive to and/or on condition that the DMRS received in PBCH is in the first PBCH DMRS set. Alternatively, and/or additionally, the WTRU may determine that a DMRS received in a PBCH is in a second PBCH DMRS set, and may determine a second value for the Q parameter based on, responsive to and/or on condition that the DMRS received in the PBCH is in the second PBCH DMRS set. In various embodiments, the values for the Q parameter may be from a list, including but not limited to {1,4,8,16,24,32, 48, 64, 72, 128, . . . }.

In various embodiments, a WTRU may determine that a DMRS received in a PBCH is in a first PBCH DMRS set, and may determine a first value for the maximum candidate SSB positions within an SSB burst based on, responsive to and/or on condition that the DMRS received in the PBCH is in the first PBCH DMRS set. Alternatively, and/or additionally, the WTRU may determine that a DMRS received in a PBCH is in a second PBCH DMRS set, and may determine a second value for the maximum candidate SSB positions within an SSB burst based on, responsive to and/or on condition that the DMRS received in the PBCH is in the second PBCH DMRS set. For example, the WTRU may determine the maximum candidate SSB positions within an SSB burst to be a first value (e.g., 64) in operation without shared spectrum channel access. Alternatively, and/or additionally, the UE may determine the maximum candidate SSB positions within an SSB burst to be a second value (e.g., 128 or more) in operation with shared spectrum channel access.

In various embodiments, a WTRU may determine that DBTW is enabled for SSB burst transmission based on, responsive to and/or on condition that the WTRU determines that a DMRS received in a PBCH is in a first PBCH DMRS set. Alternatively, and/or additionally, the WTRU may determine that DBTW is disabled for SSB burst transmission based on, responsive to and/or on condition that the WTRU determines that a DMRS received in a PBCH is in a second PBCH DMRS set. Alternatively, and/or additionally, the WTRU may determine that LBT is exempted in SSB burst transmission (e.g., due to short control signaling) based on, responsive to and/or on condition that the WTRU determines that a DMRS received in a PBCH is in a third PBCH DMRS set.

In various embodiments, a WTRU may determines a DMRS received in a PBCH is in a first PBCH DMRS set, and may receive an associated PBCH in a first mode of operation based on, responsive to and/or on condition that the DMRS received in the PBCH is in the first PBCH DMRS set. Alternatively, and/or additionally, the WTRU may determine a DMRS received in a PBCH is in a second PBCH DMRS set, and may receive an associated PBCH in a second mode of operation based on, responsive to and/or on condition that the DMRS received in the PBCH is in the second PBCH DMRS set. One or more payload bits of the PBCH (e.g., MIB) may be interpreted differently based on the mode of operation. Time/frequency location of the PBCH may be determined based on the mode of operation.

In various embodiments, SSB time/frequency location and/or a maximum number of SSBs may be different based on the mode of operation. A WTRU may perform SSB detection procedures based on the determined mode of operation. For example, in case of operation with shared spectrum and based on the Q parameter, the WTRU may monitor candidate SSB positions to detect SSBs that are transmitted with the same QCL relation as the missed SSBs, e.g., due to LBT failure.

In various embodiments, a WTRU may determine that a DMRS received in a PBCH is in a first PBCH DMRS set, and may employ a first set of parameters for detection of a CORESET #0 and a Type-0 PDCCH monitoring based on, responsive to and/or on condition that the DMRS received in the PBCH is in the first PBCH DMRS set. Alternatively, and/or additionally, the WTRU may determine that a DMRS received in a PBCH is in a second PBCH DMRS set, and may employ a second set of parameters for detection of a CORESET #0 and a Type-0 PDCCH monitoring based on, responsive to and/or on condition that the DMRS received in the PBCH is in the second PBCH DMRS set. For example, in the case of operation with shared spectrum channel access, the number of symbols, number of RBs, RB offset values, multiplexing pattern, and so forth may be selected from a first set of parameters and/or indexed tables. Alternatively, and/or additionally, in the case of operation without shared spectrum channel access, the number of symbols, number of RBs, RB offset values, multiplexing pattern, and so forth may be selected from a second set of parameters and/or indexed tables. As an example, the WTRU may receive a Type-0 PDCCH search space configuration from the associated PBCH based on, responsive to and/or on condition that the WTRU received or detected PBCH DMRS in a first PBCH DMRS set. Alternatively, and/or additionally, full or partial configuration information for a Type-0 PDCCH search space may be predefined or pre-configured based on, responsive to and/or on condition that the WTRU received or detected PBCH DMRS in a second PBCH DMRS set.

In various embodiments, a WTRU may perform channel sensing (e.g., LBT procedures) before transmission based on the mode of operation. For example, a WTRU may perform LBT before an uplink transmission (e.g., PUSCH, PUCCH, PRACH, SRS) based on, responsive to and/or on condition that the WTRU determines that received or detected PBCH DMRS are in a first PBCH DMRS set. Alternatively, and/or additionally, the WTRU may not perform LBT before an uplink transmission based on, responsive to and/or on condition that the WTRU determines that received or detected PBCH DMRS are in a second PBCH DMRS set. Alternatively, and/or additionally, the WTRU may consider LBT exemption, e.g., due to short control signaling or COT sharing, in an uplink transmission based on, responsive to and/or on condition that the WTRU determines that received or detected PBCH DMRS are in a third PBCH DMRS set. For example, in operation with shared spectrum, a WTRU may perform single LBT sensing in an uplink transmission based on, responsive to and/or on condition that the WTRU determines that received or detected PBCH DMRS are in a first PBCH DMRS set. Alternatively, and/or additionally, the WTRU may perform directional LBT and/or per-beam LBT sensing in an uplink based on, responsive to and/or on condition that the WTRU determines that received or detected PBCH DMRS are in a second PBCH DMRS set.

In various embodiments, a WTRU may determine a first duplex mode (e.g., TDD) based on, responsive to and/or on condition that the WTRU determines that received or detected PBCH DMRS are in a first PBCH DMRS set. Alternatively, and/or additionally, the WTRU may determine a second duplex mode (e.g., FDD) based on, responsive to and/or on condition that the WTRU determines that received or detected PBCH DMRS are in a second PBCH DMRS set.

In various embodiments, one or more PBCH DMRS sets may be used and a WTRU may determine any of following based on the PBCH DMRS set in which the WTRU may have received, detected, or determined DMRS in a PBCH for initial access:
licensed spectrum;
unlicensed spectrum;
a PBCH type (e.g., which information is included in the PBCH);
a duplex mode (e.g., TDD, FDD, or HD-FDD);
a PRACH resource configuration;
a range of the system bandwidth;
a use case (e.g., sidelink, Uu, NTN, etc.);
an uplink transmission power (e.g., a maximum uplink transmission power);
barring of WTRU types (e.g., access baring of certain WTRU types. For example, a first type of WTRUs (e.g., a UE with a limited capability including reduced Rx antenna, smaller maximum bandwidth supported, lower maximum transmission power) may be not allowed to access the cell when SSB is located in a first sync raster set. Otherwise, the first type of WRRUs may be allowed to access the cell); and
support of a specific functionality in the network (e.g., power saving, carrier aggregation, DRX, etc.)

### Positioning Methods

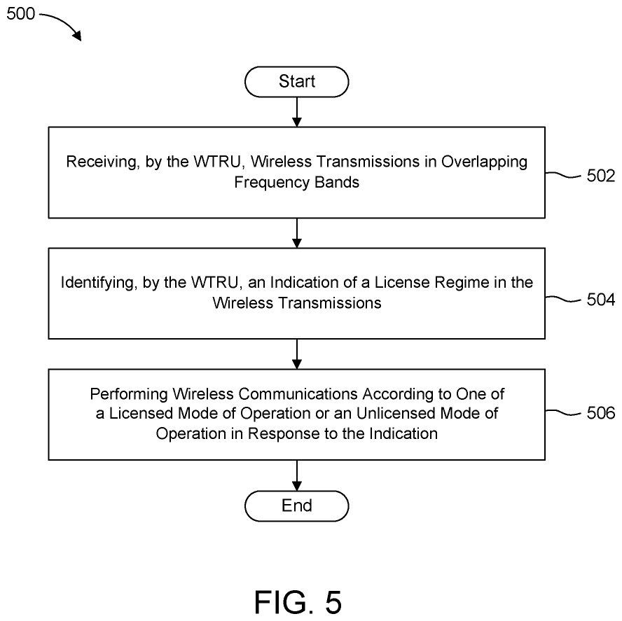

Referring to FIG. 5, a WTRU may implement a method 500 of initial access in higher frequencies. At step 502, the WTRU may receive wireless transmissions in overlapping frequency bands in any manner previously described. Processing may proceed from step 502 to step 504.

At step 504, the WTRU may identify an indication of a license regime in the wireless transmissions in any manner previously described. For example, the WTRU may identify an indication of a licensing regime in overlapping bands and/or an indication of support of discovery burst (DB)/DBTW. Processing may proceed from step 504 to step 506.

At step 506, the WTRU may perform wireless communications according to one of a licensed mode of operation or an unlicensed mode of operation in response to the indication. For example, the WTRU may select one of the modes based on the indication in any manner previously described and perform the wireless communications while operating in the selected mode.

In step 504, for instance, the WTRU may identify the indication at least in part by detecting an implicit identification of the license regime based on various criteria. Example criteria include different sync raster/offset for licensed and unlicensed regimes, a specific range of values for PCIDs, a zone identity (ID), an SCS, and/or contents of a SIB1.

In an embodiment corresponding to step 504, in the case of a different sync raster/offset for licensed and unlicensed regimes, the WTRU may search for the SSB bursts around two sync raster offsets during initial access. The two synch raster offsets may be preconfigured based on carrier frequency and SCS. The WTRU may determine if the operation band is licensed or unlicensed based on the sync raster offset where the SS/PBCH block is located.

In an embodiment corresponding to step 504, in the case of a specific range of values of PCIDs, a WTRU may identify the PCID based on PSS and SSS sequences included in a SS/PBCH block. The WTRU may be configured with a threshold for the value of PCID. The WTRU may determine if the operation band is licensed or unlicensed based on the PCID and the configured threshold, e.g., the PCID>threshold for the unlicensed bands.

In an embodiment corresponding to step 504, in the case of a zone ID, the WTRU may associate zone IDs with the license regimes to determine if the zone in which it is located uses the corresponding band as licensed or unlicensed.

In an embodiment corresponding to step 504, in the case of SCS, the WTRU may associate a specific SCS of a SS/PBCH block with a license regime to determine whether the corresponding band is licensed or unlicensed. Alternatively, or additionally, the WTRU may associate a specific SCS of a CORESET #0 and a Type0-PDCCH CSS with the license regime to determine whether the corresponding band as licensed or unlicensed.

In an embodiment corresponding to step 504, in the case of contents of a SIB1, the WTRU may identify a license regime based on a specific parameter in the SIB1. Alternatively, or additionally, the WTRU may use blind detection of a CORESET #0 and a Type0-PDCCH CSS to find a corresponding SIB1 associated to the detected SS/PBCH block. Alternatively, or additionally, the WTRU may interpret the parameters in MIB that have different purposes in licensed and unlicensed bands to detect the CORESET #0 and the Type0-PDCCH CSS to find a corresponding SIB1 associated with the detected SS/PBCH block. In an example MIB parameters interpretation, an IE controlResourceSetZero in an IE pdcch-ConfigSIB1 included in the MIB may indicate a number of consecutive resource blocks and a number of consecutive symbols for the CORESET of the Type0-PDCCH CSS set that refer to different reference tables for a licensed and unlicensed band channel access. In another example MIB parameters interpretation, an IE ssb-SubcarrierOffset corresponding to an IE k_{SSB} in the MIB may denote a frequency domain offset of the SS/PBCH block, which the WTRU may interpret differently in licensed and unlicensed band regimes. Alternatively, or additionally, the WTRU may, in blind detection in stand-alone operations, interpret the parameters in a prioritized scheme. For example, the WTRU may interpret the parameters with dual (multiple) purposes based on licensed regime first to find a CORESET #0 and a Type0-PDCCH CSS from a MIB. In case of failure in finding the CORESET #0 and the Type0-PDCCH CSS based on licensed interpretation, the WTRU may change the interpretations of the parameters based on unlicensed regime to find the CORESET #0 and the Type0-PDCCH CSS from the MIB.

Alternatively, or additionally, the WTRU may, at step 504, identify the indication at least in part by detecting an explicit identification of the license regime based on contents of a MIB. The parameters in MIB may be repurposed to identify the license regime. In an example, a MSB in the parameter (IE) controlResourceSetZero in an IE pdcch-ConfigSIB1 in the MIB is unused for SCSs higher than 120 kHz in a CORESET #0 and a Type0-PDCCH CSS. Considering the support of such SCS in FR3, the MSB bit can be used to indicate the license regime.

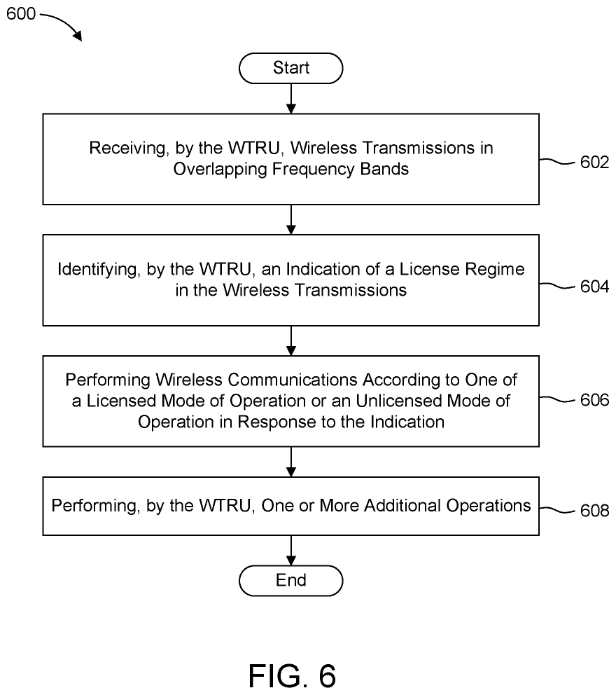

Referring to FIG. 6, a WTRU may implement method 600 of initial access in higher frequencies. Method 600 may include steps 602-606, which may correspond to steps 502-506 of FIG. 5, as previously described. Additionally, method 600 includes another step 608, which may be performed after step 606 and/or at any other stage of the process carried out by method 600.

At step 608, the WTRU may perform one or more additional operations. For example, the WTRU may, at step 608, implement support of sixty-four beams based on an explicit indication, in a MIB, of the QCL relation between the synchronization signal blocks that are quasi co-located within a same DBTW or across a plurality of DBTWs. Alternatively, or additionally, the WTRU may, at step 608, employ another indication, in a MIB, of an information block SCS (SubcarrierSpacingCommon) to select between two or more SCSs for a CORESET #0 for a Type0 PDCCH common search space (CSS) set. Alternatively, or additionally, the WTRU may, at step 608, operate in an LBT mode of operation and employ, in response to operating in the LBT mode of operation, a predetermined CORESET #0 and a predetermined Type0-PDCCH CSS. The predetermined CORESET #0 and the predetermined Type0-PDCCH CSS may be configured to ensure that gaps between SS/PBCH blocks in a synchronization signal block burst are occupied with no gaps greater than 16 us. Alternatively, or additionally, the WTRU may, at step 608, employ one or more preconfigured locations of a CORESET #0 in an SS/PBCH block with non-initial access use-cases, where the SS/PBCH block does not configure Type-0 PDCCH in SCSs of 480 kHz and 960 kHz.

In the case that the WTRU implements support of 64 beams based on an explicit indication in a MIB, the explicit indication may be based on two or three bits. For example, the explicit indication based on two bits may be based on subsample values. The two bits may be in the MIB, with an IE subcarrierSpacingCommon and an LSB of an IE ssb-SubcarrierOffset. Alternatively, or additionally, the two bits may be in the MIB with an LSB of an IE ssb-SubcarrierOffset and a MSB of an IE controlResourceSetZero. Alternatively, or additionally, the two bits may be in the MIB with an IE controlResourceSetZero and/or an IE searchSpaceZero if the fields are preconfigured. As another example, the explicit indication based on three bits may be in the MIB with an LSB of an IE ssb-SubcarrierOffset and a MSB of an IE controlResourceSetZero and one more single bit from the IE controlResourceSetZero or the IE searchSpaceZero with subsampling. As an example, the explicit indication based on three bits may be in the MIB, with an IE controlResourceSetZero and/or an IE searchSpaceZero if the fields are preconfigured.

In the case that the WTRU employs another indication, in a MIB, of an IE subcarrierSpacingCommon to select between two or more SCSs for a CORESET #0 for a Type0 PDCCH CSS set, the other indication may be one or two bits. For example, the indication may be one bit with other information. Based on an SCS of an SS/PBCH block, a single bit indication may indicate that a same/higher SCSs or a same/lower SCSs can be supported. Other blind detection methods, such as sync raster/offset and/or a specific range of values of PCIDs, may further be used in combination with the single bit. In another example, a two bit indication may be implemented using one bit from an IE subcarrierSpacingCommon and another single bit from an IE controlResourceSetZero or an IE searchSpaceZero if the fields are preconfigured.

In the case that the WTRU employs, in response to operating in the LBT mode of operation, a predetermined CORESET #0 and a predetermined Type0-PDCCH CSS, the WTRU may be preconfigured in one or more ways. For example, in LBT mode operation, the WTRU may be preconfigured with the CORESET #0 and the Type0-PDCCH CSS to ensure that gaps in between SS/PBCH blocks in an synchronization signal block burst are occupied with no gaps greater than 16 us. The WTRU may be preconfigured with a number of consecutive resource blocks and a number of consecutive symbols for the CORESET of the Type0-PDCCH CSS set. An IE controlResourceSetZero and/or an IE searchSpaceZero in an IE pdcch-ConfigSIB1 included in the MIB might not be used and it can be repurposed for other indications. In an example, a MSB of the IE controlResourceSetZero in the IE pdcch-ConfigSIB1 included in the MIB may be used to indicate a license regime of the bands. In another example, the IE controlResourceSetZero and/or IE searchSpaceZero in the IE pdcch-ConfigSIB1 included in the MIB may be used to indicate a beam index of the SS/PBCH blocks in a DBTW. In another example, the IE controlResourceSetZero and/or IE searchSpaceZero in the IE pdcch-ConfigSIB1 included in the MIB may be used to indicate a QCL relation of the SS/PBCH blocks in the DBTW. In another example, an LSB of an IE k_{SSB} in an IE ssb-SubcarrierOffset may be repurposed to indicate parameters such as beam index, QCL relations, different numerologies and/or Lmax.

In the case that the WTRU employs one or more preconfigured locations of a CORESET #0 in a SSB with non-initial access use-cases, where the SSB does not configure Type-0 PDCCH in SCSs of 480 kHz and 960 kHz, the WTRU may do so in one or more ways. For example, the WTRU may be preconfigured in NR cell measurements with the time and frequency allocation of the CORESET #0 and the Type0-PDCCH CSS to avoid BWP switch and mixed numerology measurement. Alternatively, or additionally, every other SSB with a non-initial access use case may include the preconfigured CORESET #0 and Type0-PDCCH CSS. The WTRU may be preconfigured with a number of consecutive resource blocks, a frequency offset, and a number of consecutive symbols for the CORESET of the Type0-PDCCH CSS set. For example, an IE k_{SSB} in an IE ssb-SubcarrierOffset, an IE controlResourceSetZero, and/or an IE searchSpaceZero in an IE pdcch-ConfigSIB1 included in a MIB may be used to indicate if a corresponding SSB is associated with the preconfigured CORESET #0 and Type0-PDCCH CSS.

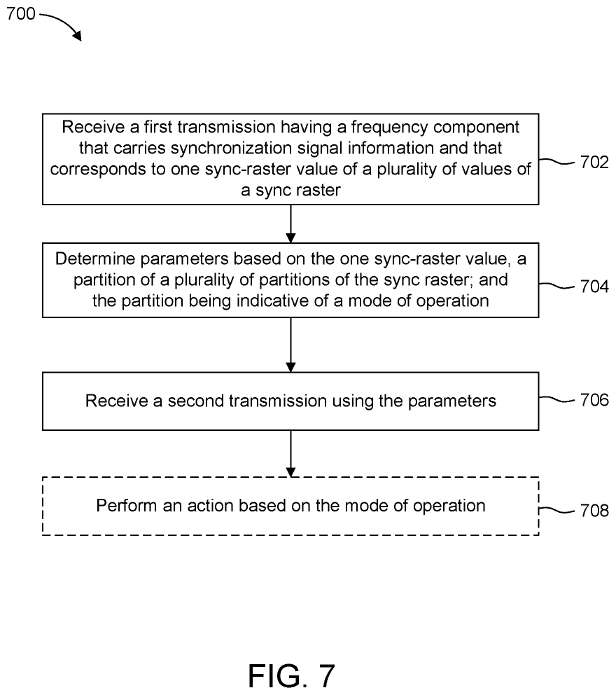

FIG. 7 is a flow chart illustrating an example flow 700 in accordance with various embodiments. For convenience and simplicity of exposition, the flow 700 and accompanying disclosures herein are described with reference to the architectures of the communications system 100 (FIG. 1). The flow 700 may be carried out using different architectures as well.

Referring now to FIG. 7, an apparatus (e.g., a WTRU, a base station, etc.) may receive a first transmission having a frequency component that may carry synchronization signal information and that may correspond to one sync-raster value of a plurality of values of a sync raster (702). In various embodiments, the frequency component may be any of a subcarrier and a subchannel.

The apparatus may determine one or more parameters based on the one sync-raster value, a partition of a plurality of partitions of the sync raster, and the partition being indicative of a mode of operation (704). For example, the apparatus may determine the parameters based on (i) the one sync-raster value being a member of a partition of a plurality of partitions of the sync raster, and (ii) the partition being indicative of a mode of operation. Alternatively, in various embodiments, the apparatus may determine the parameters based on (i) determining the mode of operation based on the one sync-raster value being a member of the partition of the plurality of partitions of the sync raster, and the partition being indicative of the mode of operation; and (ii) determining the one or more parameters based on the determined mode of operation. The parameters may be, include and/or correspond to any of one or more (e.g., consecutive) resource blocks, a number of (e.g., consecutive) resource blocks, one or more (e.g., consecutive) symbols, a number of (e.g., consecutive) symbols, a frequency offset, and a multiplexing pattern for/associated with a second transmission (e.g., associated with CORESET and/or a search space).

In various embodiments, the apparatus may perform partitioning of the sync raster into the plurality of partitions. In various embodiments, the plurality of partitions may be indicative of a respective plurality of modes of operation. In various embodiments, the partition may be any one of the plurality of partitions. In various embodiments, the partition may be based on a function applied to the plurality of sync-raster values. In various embodiments, each of the plurality of partitions may be based on a corresponding (e.g., respective) function applied to the plurality of sync-raster values. In various embodiments, the partition may be based on an initial sync-raster value and a step function applied to the plurality of sync-raster values. In various embodiments, each of the plurality of partitions may be based on an initial sync-raster value and a step function applied to the plurality of sync-raster values. In various embodiments, the first mode of operation may be, may include and/or may correspond or to licensed band operation. In various embodiments, the second mode of operation may be, may include and/or may correspond to unlicensed band operation.

The apparatus may receive a second transmission using the parameters (706). In various embodiments, the second transmission may include control channel information. In various embodiments, the control channel information may be and/or include physical downlink control channel information.

Additionally (e.g., optionally), the apparatus may perform an action based on the mode of operation (708). For example, in various embodiments, the apparatus may transmit an uplink transmission without performing a listen-before-talk operation based on the mode of operation being a first mode of operation. Alternatively, or additionally, the apparatus may perform a listen-before-talk operation based on the mode of operation being a second mode of operation, and/or transmit an uplink transmission following an outcome of the listen-before-talk operation indicating a channel is available. Alternatively, or additionally, the apparatus may, based on the mode of operation being a second mode of operation, perform a listen-before-talk operation based on the mode of operation being a second mode of operation, and/or transmit an uplink transmission following an outcome of the listen-before-talk operation indicating a channel is available. Alternatively, or additionally, the apparatus may transmit information indicating one or more of the parameters. In various embodiments, the information indicating one or more of the parameters may be, include and/or be indicated in a report.

### CONCLUSION

The following references may have been referred to hereinabove and are incorporated in full herein by reference.
3GPP TS 38.213, “NR Physical layer procedures for control”, v16.1.0
3GPP TS 38.321, “Medium Access Control (MAC) protocol specification”, v16.0.0
3GPP TS 38.331, “Radio Resource Control (RRC) protocol specification”, v16.0.0
3GPP TR 38.805, “Study on New Radio access technology; 60 GHz unlicensed spectrum”
3GPP TR 38.807, “Study on requirements for NR beyond 52.6 GHz”, v16.0.0
3GPP TR 38.913, “Study on New Radio access technology; Next Generation Access Technologies”
3GPP RP-181435, “New SID: Study on NR beyond 52.6 GHz”
3GPP RP-193259, “New SID: Study on supporting NR from 52.6 GHz to 71 GHz”
3GPP RP-193229, “New WID on Extending current NR operation to 71 GHz”.
3GPP TS 38.133, “Requirements for support of radio resource management”, v17.1.0.
3GPP TS 38.300, “NR and NG-RAN Overall Description”, v16.5.0.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented in a wireless transmit/receive unit (WTRU), the method comprising:
receiving a first transmission having a frequency component that carries synchronization signal information and that corresponds to a sync-raster value of a plurality of values of a sync raster;
determining one or more parameters based on:
(i) the sync-raster value being associated with a partition of a plurality of partitions of the sync raster; and
(ii) the partition being indicative of a mode of operation; and
receiving a second transmission using the one or more parameters, wherein the second transmission comprises control channel information.

2. The method of claim 1, comprising:
transmitting an uplink transmission without performing a listen-before-talk operation based on the mode of operation being a first mode of operation.

3. The method of claim 1, comprising:
performing a listen-before-talk operation based on the mode of operation being a second mode of operation; and
transmitting an uplink transmission following an outcome of the listen-before-talk operation indicating a channel is available.

4. The method of claim 1, comprising:
based on the mode of operation being a second mode of operation,
performing a listen-before-talk operation based on the mode of operation being a second mode of operation; and
transmitting an uplink transmission following an outcome of the listen-before-talk operation indicating a channel is available.

5. The method of claim 1, wherein the plurality of partitions is indicative of a respective plurality of modes of operation, and wherein the partition is any one of the plurality of partitions.

6. The method of claim 1, wherein the partition is based on a function applied to the plurality of sync-raster values.

7. The method of claim 1, wherein each of the plurality of partitions is based on a corresponding function applied to the plurality of sync-raster values.

8. The method of claim 1, wherein the partition is based on an initial sync-raster value and a step function applied to the plurality of sync-raster values.

9. The method of claim 1, wherein each of the plurality of partitions is based on an initial sync-raster value and a step function applied to the plurality of sync-raster values.

10. The method of claim 2, wherein the first mode of operation corresponds to licensed band operation.

11. The method of claim 3, wherein the second mode of operation corresponds to unlicensed band operation.

12. The method of claim 1, wherein determining one or more parameters comprises:
determining the mode of operation based on:
(i) the sync-raster value being a member of the partition of the plurality of partitions of the sync raster; and
(ii) the partition being indicative of the mode of operation; and
determining the one or more parameters based on the determined mode of operation.

13. The method of claim 1, wherein the control channel information comprises physical downlink control channel information.

14. The method of claim 1, wherein the frequency component is any of a subcarrier and a subchannel.

15. The method of claim 1, comprising transmitting information indicating one or more of the one or more parameters.

16. The method of claim 15, wherein the information indicating one or more of the parameters is a report.

17. The method of claim 1, wherein the sync raster is associated with frequency positions of a synchronization block.

18. The method of claim 1, wherein the one or more parameters comprise any of: one or more resource blocks, a number of resource blocks, one or more symbols, a number of symbols, a frequency offset, and a multiplexing pattern associated with a second transmission.

19. A wireless transmit/receive unit (WTRU), comprising:
circuitry, including any of a processor, memory, transmitter and receiver, the circuitry configured to:
receive a first transmission having a frequency component that carries synchronization signal information and that corresponds to a sync-raster value of a plurality of values of a sync raster;
determine one or more parameters based on:
(i) the sync-raster value being associated with a partition of a plurality of partitions of the sync raster; and
(ii) the partition being indicative of a mode of operation; and
receive a second transmission using the one or more parameters, wherein the second transmission comprises control channel information.

20. The WTRU of claim 19, the circuitry configured to:
transmit an uplink transmission without performing a listen-before-talk operation based on the mode of operation being a first mode of operation.

21. The WTRU of claim 19, the circuitry configured to:
perform a listen-before-talk operation based on the mode of operation being a second mode of operation; and
transmit an uplink transmission following an outcome of the listen-before-talk operation indicating a channel is available.

22. The WTRU of claim 19, the circuitry configured to:
based on the mode of operation being a second mode of operation,
perform a listen-before-talk operation based on the mode of operation being a second mode of operation; and
transmit an uplink transmission following an outcome of the listen-before-talk operation indicating a channel is available.

23. The WTRU of claim 19, wherein the plurality of partitions is indicative of a respective plurality of modes of operation, and wherein the partition is any one of the plurality of partitions.

24. The WTRU of claim 19, wherein the partition is based on a function applied to the plurality of sync-raster values.

25. The WTRU of claim 19, wherein each of the plurality of partitions is based on a corresponding function applied to the plurality of sync-raster values.

26. The WTRU of claim 19, wherein the partition is based on an initial sync-raster value and a step function applied to the plurality of sync-raster values.

27. The WTRU of claim 19, wherein each of the plurality of partitions is based on an initial sync-raster value and a step function applied to the plurality of sync-raster values.

28. The WTRU of claim 20, wherein the first mode of operation corresponds to licensed band operation.

29. The WTRU of claim 21, wherein the second mode of operation corresponds to unlicensed band operation.

30. The WTRU of claim 19, wherein the circuitry is configured to:
determining the mode of operation based on:
(i) the sync-raster value being a member of the partition of the plurality of partitions of the sync raster; and
(ii) the partition being indicative of the mode of operation; and
determining the one or more parameters based on the determined mode of operation.

31. The WTRU of claim 19, wherein the control channel information comprises physical downlink control channel information.

32. The WTRU of claim 19, wherein the frequency component is any of a subcarrier and a subchannel.

33. The WTRU of claim 19, the circuitry configured to:
transmit information indicating one or more of the one or more parameters.

34. The WTRU of claim 33, wherein the information indicating one or more of the parameters is a report.

35. The WTRU of claim 19, wherein the sync raster is associated with frequency positions of a synchronization block.

36. The WTRU of claim 19, wherein the one or more parameters comprise any of: one or more resource blocks, a number of resource blocks, one or more symbols, a number of symbols, a frequency offset, and a multiplexing pattern associated with a second transmission.
